(19) United States
(12) Patent Application Publication
(10) Pub. No.: US 2025/0149231 A1
(43) Pub. Date: May 8, 2025

(54) COIL ELECTRONIC COMPONENT

(71) Applicant: SAMSUNG ELECTRO-MECHANICS CO., LTD., Suwon-si (KR)

(72) Inventors: Juhwan Yang, Suwon-si (KR); Minji Cho, Suwon-si (KR); Boumseock Kim, Suwon-si (KR)

(73) Assignee: SAMSUNG ELECTRO-MECHANICS CO., LTD., Suwon-si (KR)

(21) Appl. No.: 18/906,832

(22) Filed: Oct. 4, 2024

(30) Foreign Application Priority Data
Nov. 7, 2023 (KR) 10-2023-0152568
Mar. 7, 2024 (KR) 10-2024-0032748

(51) Int. Cl. H01F 27/28; H01F 27/32

(52) U.S. Cl. CPC H01F 27/2823; H01F 27/323

(57) ABSTRACT

A coil electronic component includes a first coil including at least one turn of a first conductive wire; a second coil including at least one turn of a second conductive wire and opposing the first coil; an intermediate layer disposed from a first region between a first core of the first coil and a second core of the second coil to a second region between the first coil and the second coil and including a first magnetic material; and a main body surrounding the first coil, the second coil, and the intermediate layer and including a second magnetic material, wherein cross-sections of the first conductive wire and the second conductive wire each have a rectangular shape and satisfy the following Formulas 1 and 2:

$$0 < w 1 \leq t 1 < T 1 / 2 \qquad [ Formula 1 ]$$

$$0 < w {1}^{′} \leq t {1}^{′} < T 1 / 2. \qquad [ Formula 2 ]$$

### CROSS-REFERENCE TO RELATED APPLICATION

This application claims priority to and the benefit of Korean Patent Application No. 10-2024-0032748 filed in the Korean Intellectual Property Office on Mar. 7, 2024, and Korean Patent Application No. 10-2023-0152568 filed in the Korean Intellectual Property Office on Nov. 7, 2023, the entire contents of which are incorporated herein by reference.

### BACKGROUND

### Field

The present disclosure relates to a coil electronic component.

### Description of the Related Art

Recently, as functions of mobile devices have become more diverse, power consumption has increased, and a coil electronic component with low loss and excellent efficiency is being adopted around a power management integrated circuit (PMIC) to extend battery life in mobile devices.

The coil electronic component may have a wound-type coupled inductor structure in which a first coil and a second coil are vertically arranged. In this case, a magnitude of a direct current resistance (Rdc) or an inductance may vary depending on cross-sectional shapes of conductive wires used as the first and second coils.

### SUMMARY

An aspect of an embodiment attempts to provide a coil electronic component having a wound-type coupled inductor structure with an increased degree of design freedom by applying conductive wires of various shapes.

However, the problems to be solved by the embodiments are not limited to the above-described problems, and can be variously expanded within the scope of the technical spirit included in the embodiments.

A coil electronic component according to an embodiment includes a first coil including a first core and at least one turn of a first conductive wire; a second coil including a second core and at least one turn of a second conductive wire, the second coil opposing the first coil along a first direction; an intermediate layer disposed from a first region between the first core and the second core to a second region between the first coil and the second coil, the intermediate layer including a first magnetic material; and a main body surrounding the first coil, the second coil, and the intermediate layer, the main body including a second magnetic material, wherein a cross-section of the first conductive wire has a rectangular shape and satisfies Formula 1, and a cross-section of the second conductive wire has a rectangular shape and satisfies Formula 2.

$$0 < w 1 \leq t 1 < T 1 / 2 \qquad [ Formula 1 ]$$

$$0 < w {1}^{′} \leq t {1}^{′} < T 1 / 2 \qquad [ Formula 2 ]$$

where,
t1: thickness of the cross-section of the first conductive wire
w1: width of the cross-section of the first conductive wire
t1′: thickness of the cross-section of the second conductive wire
w1′: width of the cross-section of the second conductive wire
T1: thickness of the main body

In some embodiments, based on a cross-section of the coil electronic component taken along a direction parallel to the first direction, a ratio of a sum of cross-sectional areas of the first coil and the second coil to a cross-sectional area of the main body may be 0.048 or more and 0.200 or less.

In some embodiments, the first coil may include 7.81 turns or more and 27.17 turns or less of the first conductive wire, and the second coil may include 7.81 turns or more and 27.17 turns or less of the second conductive wire.

In some embodiments, w1, t1, w1′, and t1′ may satisfy the following ranges, respectively.

$$0.0075 \leq w 1 / L 1 \leq 0.02735 , 0.0548 \leq t 1 / T 1 \leq 0.2 , \\ 0.0075 \leq w {1}^{′} / L 1 \leq 0.02735 , 0.0548 \leq t {1}^{′} / T 1 \leq 0.2 ,$$

where,
L1: length of the main body

In some embodiments, the first coil may include 4.5 turns of the first conductive wire, the second coil may include 4.5 turns of the second conductive wire, a value obtained by dividing a width of the first core by a length of the main body may be 0.3905 or more and 0.47 or less, and a value obtained by dividing a width of the second core by the length of the main body may be 0.3905 or more and 0.47 or less.

In some embodiments, based on a cross-section taken along a direction parallel to the first direction, a ratio of a sum of cross-sectional areas of the first coil and the second coil to a cross-sectional area of the main body may be 0.025 to 0.027.

A coil electronic component according to an embodiment includes a first coil including a first core and at least one turn of a first conductive wire; a second coil including a second core and at least one turn of a second conductive wire, the second coil opposing the first coil along a first direction; an intermediate layer disposed from a first region between the first core and the second core to a second region between the first coil and the second coil, the intermediate layer including a first magnetic material; and a main body surrounding the first coil, the second coil, and the intermediate layer, the main body including a second magnetic material, wherein a cross-section of the first conductive wire has a circular shape and satisfies Formula 3, and a cross-section of the second conductive wire has a circular shape and satisfies Formula 4.

$$0 < D 1 < L 2 / 2 \qquad [ Formula 3 ]$$

$$0 < D 2 < L 2 / 2 \qquad [ Formula 4 ]$$

where,
D1: diameter of the cross-section of the first conductive wire
D2: diameter of the cross-section of the second conductive wire
L2: length of the main body

In some embodiments, based on a cross-section of the coil electronic component taken along a direction parallel to the first direction, a ratio of a sum of cross-sectional areas of the first coil and the second coil to a cross-sectional area of the main body may be 0.012 or more and 0.151 or less.

In some embodiments, the first coil may include 2.5 turns or more and 23.2 turns or less of the first conductive wire, and the second coil may include 2.5 turns or more and 23.2 turns or less of the second conductive wire.

In some embodiments, D1 and D2 may each satisfy the following ranges.

$$0.0088 < D 1 / L 2 \leq 0.1 , 0.0088 < D 2 / L 2 \leq 0.1 , \\ 0.0176 < D 1 / T 2 \leq 0.2 , 0.0176 < D 2 / T 2 \leq 0.2 ,$$

where,
L2: length of the main body
T2: thickness of the main body

In some embodiments, the first coil may include 4.5 turns of the first conductive wire, the second coil may include 4.5 turns of the second conductive wire, a value obtained by dividing a width of the first core by the length of the main body may be 0.1 or more and 0.4785 or less, and a value obtained by dividing a width of the second core by the length of the main body may be 0.1 or more and 0.4785 or less.

In some embodiments, based on a cross-section taken along a direction parallel to the first direction, a ratio of a sum of cross-sectional areas of the first coil and the second coil to a cross-sectional area of the main body may be 0.001 or more and 0.354 or less.

A coil electronic component according to still another embodiment includes a first coil including a first core and at least one turn of a first conductive wire; a second coil including a second core and at least one turn of a second conductive wire, the second coil opposing the first coil along a first direction; an intermediate layer disposed from a first region between the first core and the second core to a second region between the first coil and the second coil, the intermediate layer including a first magnetic material; and a main body surrounding the first coil, the second coil, and the intermediate layer, the main body including a second magnetic material, wherein a cross-section of the first conductive wire has an elliptical shape and satisfies Formula 5, and a cross-section of the second conductive wire has an elliptical shape and satisfies Formula 6.

$$0 < b 1 < a 1 < L 3 / 2 \qquad [ Formula 5 ]$$

$$0 < b 2 < a 2 < L 3 / 2 \qquad [ Formula 6 ]$$

where,
a1: length of a major axis of the cross-section of the first conductive wire
b1: length of a minor axis of the cross-section of the first conductive wire
a2: length of a major axis of the cross-section of the second conductive wire
b2: length of a minor axis of the cross-section of the second conductive wire
L3: length of the main body

In some embodiments, based on a cross-section taken along a direction parallel to the first direction, a ratio of a sum of cross-sectional areas of the first coil and the second coil to a cross-sectional area of the main body may be 0.0201 to 0.0205.

In some embodiments, the first coil may include 1.8 turns or more and 11.9 turns or less of the first conductive wire, and the second coil may include 1.8 turns or more and 11.9 turns or less of the second conductive wire.

In some embodiments, a1, b1, a2, and b2 may satisfy the following ranges, respectively.

$$0.0175 \leq a 1 / L 3 \leq 0.15 , 0.028 < b 1 / T 3 < 0.032 \\ 0.0175 \leq a 2 / L 3 \leq 0.15 , 0.028 < b 2 / T 3 < 0.032$$

where,
L3: length of the main body
T3: thickness of the main body

In some embodiments, the first coil may include 4.5 turns of the first conductive wire, the second coil may include 4.5 turns of the second conductive wire, a value obtained by dividing a width of the first core by the length of the main body may be 0.1 or more and 0.43 or less, and a value obtained by dividing a width of the second core by the length of the main body may be 0.1 or more and 0.43 or less.

In some embodiments, based on a cross-section taken along a direction parallel to a direction in which the first coil and the second coil oppose each other, a ratio of a sum of cross-sectional areas of the first coil and the second coil to a cross-sectional area of the main body may be 0.007 or more and 0.0412 or less.

In some embodiments, a1, b1, a2, and b2 may satisfy the following ranges, respectively.

$$0.0175 \leq a 1 / L 3 \leq 0.1 , 0.028 < b 1 / T 3 < 0.032 \\ 0.0175 \leq a 2 / L 3 \leq 0.1 , 0.028 < b 2 / T 3 < 0.032$$

where,
L3: length of the main body
T3: thickness of the main body

A coil electronic component according to yet another embodiment includes a first coil including a first core and at least one turn of a first conductive wire; a second coil including a second core and at least one turn of a second conductive wire, the second coil opposing the first coil along a first direction; an intermediate layer disposed from a first region between the first core and the second core to a second region between the first coil and the second coil, the intermediate layer including a first magnetic material; and a main body surrounding the first coil, the second coil, and the intermediate layer, the main body including a second magnetic material, wherein a cross-section of each the first conductive wire and the second conductive wire includes opposing portions that oppose each other and a curved portion that connects the opposing portions, the cross-section of the first conductive wire satisfies Formula 7, and the cross-section of the second conductive wire satisfies Formula 8.

$$0 < t 2 < w 2 < L 4 / 2 \qquad [ Formula 7 ]$$

$$0 < t {2}^{′} \leq w {2}^{′} < L 4 / 2 \qquad [ Formula 8 ]$$

where,
t2: thickness of the cross-section of the first conductive wire
w2: width of the cross-section of the first conductive wire
t2′: thickness of the cross-section of the second conductive wire
w2′: width of the cross-section of the second conductive wire
L4: length of the main body

In some embodiments, based on a cross-section taken along a direction parallel to the first direction, a ratio of a sum of cross-sectional areas of the first coil and the second coil to a cross-sectional area of the main body may be 0.0208 or more and 0.0245 or less.

In some embodiments, the first coil may include 1.8 turns or more and 11.9 turns or less of the first conductive wire, and the second coil may include 1.8 turns or more and 11.9 turns or less of the second conductive wire.

In some embodiments, w2, t2, w2′, and t2′ may satisfy the following ranges, respectively.

$$0.0175 \leq w 2 / L 4 \leq 0.15 , 0.028 < t 2 / T 4 < 0.032 \\ 0.0175 \leq w {2}^{′} / L 4 \leq 0.15 , 0.028 < t {2}^{′} / T 4 < 0.032$$

where,
L4: length of the main body
T4: thickness of the main body

In some embodiments, the first coil may include 4.5 turns of the first conductive wire, the second coil may include 4.5 turns of the second conductive wire, a value obtained by dividing a width of the first core by the length of the main body may be 0.1 or more and 0.43 or less, and a value obtained by dividing a width of the second core by the length of the main body may be 0.1 or more and 0.43 or less.

In some embodiments, based on a cross-section taken along a direction parallel to the first direction, a ratio of a sum of cross-sectional areas of the first coil and the second coil to a cross-sectional area of the main body may be 0.0072 or more and 0.0503 or less.

In some embodiments, w2, t2, w2′, and t2′ may satisfy the following ranges, respectively.

$$0.0175 \leq w 2 / L 4 \leq 0.1 , 0.028 < t 2 / T 4 < 0.032 \\ 0.0175 \leq w {2}^{′} / L 4 \leq 0.1 , 0.028 < t {2}^{′} / T 4 < 0.032$$

where,
L4: length of the main body
T4: thickness of the main body

A coil electronic component according to an embodiment includes a first coil including a first core and at least one turn of a first conductive wire, the first coil including a first outer layer and a first inner layer; a second coil including a second core and at least one turn of a second conductive wire, the second coil opposing the first coil along a first direction and including a second outer layer and a second inner layer, wherein the second inner layer is on the first inner layer; an intermediate layer disposed from a first region between the first core and the second core to a second region between the first coil and the second coil, the intermediate layer including a first magnetic material; and a main body surrounding the first coil, the second coil, and the intermediate layer, the main body including a second magnetic material, wherein a cross-section of the first conductive wire has a rectangular shape and satisfies Formula 1, wherein a cross-section of the second conductive wire has a rectangular shape and satisfies Formula 2:

$$0 < w 1 \leq t 1 < T 1 / 2 \qquad [ Formula 1 ]$$

$$0 < w {1}^{′} \leq t {1}^{′} < T 1 / 2 \qquad [ Formula 2 ]$$

where,
t1: thickness of the cross-section of the first conductive wire
w1: width of the cross-section of the first conductive wire
t1′: thickness of the cross-section of the second conductive wire
w1′: width of the cross-section of the second conductive wire
T1: thickness of the main body, and
wherein, based on a cross-section of the coil electronic component taken along a direction parallel to the first direction, a ratio of a sum of cross-sectional areas of the first coil and the second coil to a cross-sectional area of the main body may be 0.048 or more and 0.200 or less.

In some embodiments, w1, t1, w1′, and t1′ may satisfy the following ranges, respectively:

$$0.0075 \leq w 1 / L 1 \leq 0.02735 , 0.0548 \leq t 1 / T 1 \leq 0.2 , \\ 0.0075 \leq w {1}^{′} / L 1 \leq 0.02735 , 0.0548 \leq t {1}^{′} / T 1 \leq 0.2 ,$$

where L1: length of the main body.

In some embodiments, the first coil may include 7.81 turns or more and 27.17 turns or less of the first conductive wire.

In some embodiments, the second coil may include 7.81 turns or more and 27.17 turns or less of the second conductive wire.

A coil electronic component according to an embodiment includes a first coil including a first core and at least one turn of a first conductive wire, the first coil including a first outermost turn coil, and a first intermediate turn coil having a central axis that is eccentric from a central axis of the first outermost turn coil; a second coil including a second core and at least one turn of a second conductive wire, the second coil opposing the first coil along a first direction; an intermediate layer disposed from a first region between the first core and the second core to a second region between the first coil and the second coil, the intermediate layer including a first magnetic material; and a main body surrounding the first coil, the second coil, and the intermediate layer, the main body including a second magnetic material, wherein a cross-section of the first conductive wire has a circular shape and satisfies Formula 3, and a cross-section of the second conductive wire has a circular shape and satisfies Formula 4,

$$0 < D 1 < L 2 / 2 \qquad [ Formula 3 ]$$

$$0 < D 2 < L 2 / 2 \qquad [ Formula 4 ]$$

where,
D1: diameter of the cross-section of the first conductive wire
D2: diameter of the cross-section of the second conductive wire
L2: length of the main body.

In some embodiments, the second coil may include a second outermost turn coil, and a second intermediate turn coil having a central axis that is eccentric from a central axis of the second outermost turn coil.

In some embodiments, based on a cross-section of the coil electronic component taken along a direction parallel to the first direction, a ratio of a sum of cross-sectional areas of the first coil and the second coil to a cross-sectional area of the main body may be 0.012 or more and 0.151 or less,

In some embodiments, D1 and D2 may each satisfy the following ranges:

$$0.0088 < D 1 / L 2 \leq 0.1 , 0.0088 < D 2 / L 2 \leq 0.1 , \\ 0.0176 < D 1 / T 2 \leq 0.2 , 0.0176 < D 2 / T 2 \leq 0.2 ,$$

where T2: thickness of the main body.

In some embodiments, the first coil may include 2.5 turns or more and 23.2 turns or less of the first conductive wire.

In some embodiments, the second coil may include 2.5 turns or more and 23.2 turns or less of the second conductive wire.

According to the embodiments, a coil electronic component with various characteristics by increasing a degree of design freedom of a wound-type coupled inductor can be provided.

### BRIEF DESCRIPTION OF THE DRAWINGS

FIG. 1 is a perspective view schematically showing a coil electronic component according to an embodiment.

FIG. 2 is a plan view schematically showing the coil electronic component in FIG. 1.

FIG. 3 is a bottom view schematically showing the coil electronic component in FIG. 1.

FIG. 4 is a schematic cross-sectional view taken along line IV-IV′ in FIG. 1.

FIG. 5 is a cross-sectional view schematically showing a coil electronic component according to another embodiment.

FIG. 6 is a cross-sectional view schematically showing a coil electronic component according to still another embodiment.

FIG. 7 is a cross-sectional view schematically showing a coil electronic component according to yet another embodiment.

### DETAILED DESCRIPTION

In the following detailed description, only certain embodiments of the present disclosure have been shown and described, simply by way of illustration. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

Throughout the specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Further, throughout the specification, when it is referred to as “on a plane”, it means when a target part is viewed from above, and when it is referred to as “on a cross-section”, it means when the cross-section obtained by cutting a target part vertically is viewed from the side.

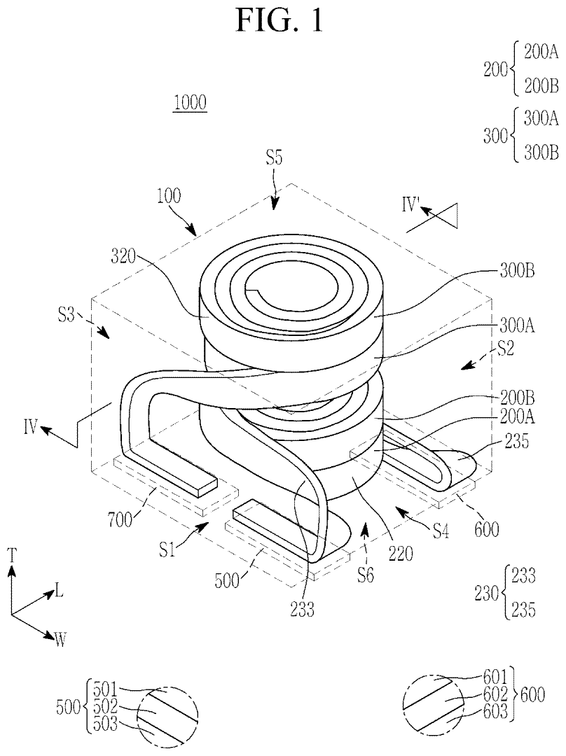

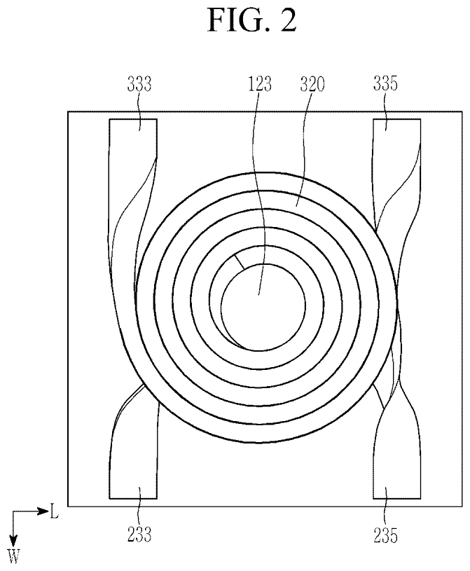

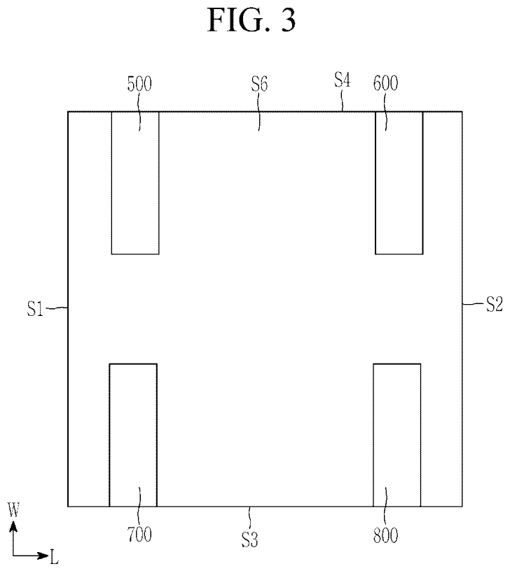

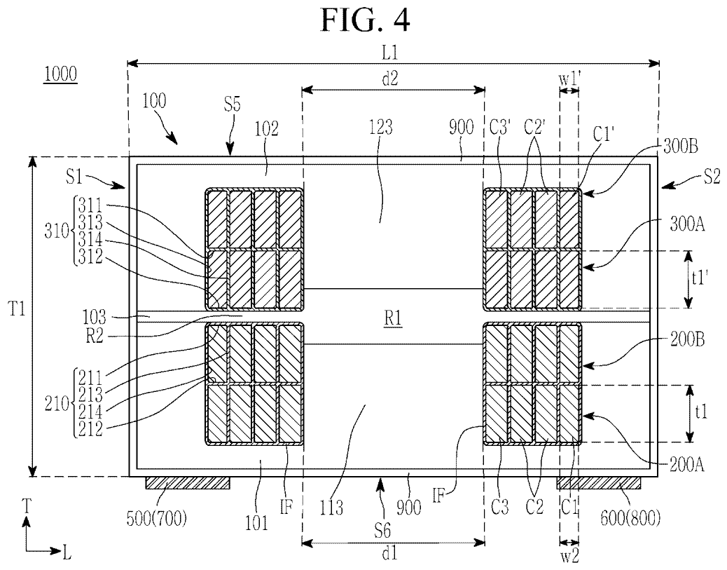

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function. FIG. 1 is a perspective view schematically showing a coil electronic component according to an embodiment, FIG. 2 is a plan view schematically showing the coil electronic component in FIG. 1, FIG. 3 is a bottom view schematically showing the coil electronic component in FIG. 1, and FIG. 4 is a schematic cross-sectional view taken along line IV-IV′ in FIG. 1.

Referring to FIGS. 1, 2, 3, and 4, a coil electronic component 1000 according to an embodiment includes a main body 100, a first coil 200, a second coil 300, a first external electrode 500, a second external electrode 600, a third external electrode 700, and a fourth external electrode 800.

The main body 100 may have a substantially rectangular parallelepiped shape, but the present embodiment is not limited thereto. Due to shrinkage of magnetic powder or the like during sintering, the main body 100 may not have a complete rectangular parallelepiped shape but may have a substantially rectangular parallelepiped shape. For example, the main body 100 has a substantially rectangular parallelepiped shape, but portions corresponding to corners or vertices may have a rounded shape.

In the present embodiment, for convenience of description, two surfaces opposing each other in a length direction (L-axis direction) are defined as a first surface S1 and a second surface S2, respectively, two surfaces opposing each other in a width direction (W-axis direction) are defined as a third surface S3 and the fourth surface S4, respectively, and two surfaces opposing each other in a thickness direction (T-axis direction) are defined as a fifth surface S5 and a sixth surface S6, respectively.

A length of the coil electronic component 1000 may mean, based on an optical microscope or scanning electron microscope (SEM) photograph of a cross-section in the length direction (L-axis direction) and the thickness direction (T-axis direction) at a central portion of the coil electronic component 1000 in the width direction (W-axis direction), a maximum value among lengths of a plurality of line segments, each of which connects two outermost boundary lines opposing each other in the length direction (L-axis direction) of the coil electronic component 1000 shown in the cross-section photograph and is parallel to the length direction (L-axis direction). Alternatively, the length of the coil electronic component 1000 may mean a minimum value among lengths of a plurality of line segments, each of which connects two outermost boundary lines opposing each other in the length direction (L-axis direction) of the coil electronic component 1000 shown in the cross-section photograph and is parallel to the length direction (L-axis direction). Alternatively, the length of the coil electronic component 1000 may mean an arithmetic average value of lengths of at least two line segments among a plurality of line segments, each of which connects two outermost boundary lines opposing each other in the length direction (L-axis direction) of the coil electronic component 1000 shown in the cross-section photograph and is parallel to the length direction (L-axis direction).

A thickness of the coil electronic component 1000 may mean, based on an optical microscope or scanning electron microscope (SEM) photograph of a cross-section in the length direction (L-axis direction) and the thickness direction (T-axis direction) at a central portion of the coil electronic component 1000 in the width direction (W-axis direction), a maximum value among lengths of a plurality of line segments, each of which connects two outermost boundary lines opposing each other in the thickness direction (T-axis direction) of the coil electronic component 1000 shown in the cross-section photograph and is parallel to the thickness direction (T-axis direction). Alternatively, the thickness of the coil electronic component 1000 may mean a minimum value among lengths of a plurality of line segments, each of which connects two outermost boundary lines opposing each other in the thickness direction (T-axis direction) of the coil electronic component 1000 shown in the cross-section photograph and is parallel to the thickness direction (T-axis direction). Alternatively, the thickness of the coil electronic component 1000 may mean an arithmetic average value of lengths of at least two line segments among a plurality of line segments, each of which connects two outermost boundary lines opposing each other in the thickness direction (T-axis direction) of the coil electronic component 1000 shown in the cross-section photograph and is parallel to the thickness direction (T-axis direction).

A width of the coil electronic component 1000 may mean, based on an optical microscope or scanning electron microscope (SEM) photograph of a cross-section in the length direction (L-axis direction) and the width direction (W-axis direction) at a central portion of the coil electronic component 1000 in the thickness direction (T-axis direction), a maximum value among lengths of a plurality of line segments, each of which connects two outermost boundary lines opposing each other in the width direction (W-axis direction) of the coil electronic component 1000 shown in the cross-section photograph and is parallel to the width direction (W-axis direction). Alternatively, the width of the coil electronic component 1000 may mean a minimum value among lengths of a plurality of line segments, each of which connects two outermost boundary lines opposing each other in the width direction (W-axis direction) of the coil electronic component 1000 shown in the cross-section photograph and is parallel to the width direction (W-axis direction). Alternatively, the width of the coil electronic component 1000 may mean an arithmetic average value of lengths of at least two line segments among a plurality of line segments, each of which connects two outermost boundary lines opposing each other in the width direction (W-axis direction) of the coil electronic component 1000 shown in the cross-section photograph and is parallel to the width direction (W-axis direction).

The length, width, and thickness of the coil electronic component 1000 may each be measured using a micrometer measurement method. The micrometer measurement method may be performed by setting a zero point using a Gage R&R (repeatability and reproducibility), inserting the coil electronic component 1000 according to the present embodiment between tips of the micrometer, and turning a measurement lever of the micrometer. Meanwhile, when measuring the length of the coil electronic component 1000 by using the micrometer measurement method, the length of the coil electronic component 1000 may mean a value measured once, or may mean an arithmetic average of values measured multiple times. The same may also apply to the measurement of the width and thickness of the coil electronic component 1000.

The main body 100 constitutes an exterior of the coil electronic component 1000, and has a space where a magnetic path, which is a path through which the magnetic flux induced by the first coil 200 and the magnetic flux induced by the second coil 300 pass, is formed, when current is applied to the first coil 200 through the first external electrode 500 and the second external electrode 600 and current is applied to the second coil 300 through the third external electrode 700 and the fourth external electrode 800.

The main body 100 surrounds and encapsulates the first coil 200 and the second coil 300 and includes a magnetic material. The main body 100 includes magnetic particles, and an insulating material may be interposed between the magnetic particles.

The magnetic material may include a first metal magnetic powder, a second metal magnetic powder having a larger particle diameter than that of the first metal magnetic powder, and a third metal magnetic powder having a larger particle diameter than that of the second metal magnetic powder. An average particle diameter (D₅₀) of the first metal magnetic powder may be 0.1 μm or more and 0.2 μm or less, and an average particle diameter (D₅₀) of the second metal magnetic powder may be 1 μm or more and 2 μm or less, and an average particle diameter (D₅₀) of the third metal magnetic powder may be 25 μm or more and 30 μm or less.

The magnetic particles may be ferrite particles or metal magnetic particles that exhibit magnetic properties.

The ferrite particles may include, for example, at least one of spinel-type ferrites such as Mg—Zn-based ferrites, Mn—Zn-based ferrites, Mn—Mg-based ferrites, Cu—Zn-based ferrites, Mg—Mn—Sr-based ferrites, and Ni—Zn-based ferrites, hexagonal ferrites such as Ba—Zn-based ferrites, Ba—Mg-based ferrites, Ba—Ni-based ferrites, Ba—Co-based ferrites, and Ba—Ni—Co-based ferrites, garnet-type ferrites such as Y-based ferrites, and Li-based ferrites.

The metal magnetic particles may include two or more types of powder particles having different compositions, and may include one or more selected from the group consisting of iron (Fe), silicon (Si), chromium (Cr), cobalt (Co), molybdenum (Mo), aluminum (AI), niobium (Nb), copper (Cu), and nickel (Ni). For example, the metal magnetic particles may be pure iron or soft magnetic alloys. When the metal magnetic particles are soft magnetic alloys, the metal magnetic particles may include one or more of Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, and Fe—Cr—Al-based alloy. Here, different compositions of the metal magnetic particles may mean different contents.

The metal magnetic particles may be amorphous or crystalline. For example, the metal magnetic particles may be of Fe—Si—B—Cr-based amorphous alloys, but the present embodiment is not limited thereto. The metal magnetic particles may have an average particle diameter of about 0.1 μm to 30 μm, but are not limited thereto. In the present specification, the average particle diameter may refer to a particle size distribution expressed as D₉₀, D₅₀, or the like. The particle size distribution is well known to one skilled in the art as an indicator of what proportion of particles of what size (particle diameter) are contained within a population of particles to be measured. D₅₀ (particle diameter corresponding to 50% of the cumulative volume of the particle size distribution) refers to an average particle diameter.

The metal magnetic particles may be two or more types of different metal magnetic particles. Here, different types of metal magnetic particles mean that the metal magnetic particles are distinguished from each other in at least one of average particle diameter, composition, component ratio, crystallinity, and shape. The insulating material may include epoxy, polyimide, liquid crystalline polymer, and the like, alone or in admixture, but is not limited thereto.

The method of forming the main body 100 is not particularly limited. For example, the main body 100 may be formed by placing sheets of magnetic material on the lower portion of the first coil 200, between the first coil 200 and the second coil 300, and on the upper portion of the second coil 300, and then pressing and curing the same. As another example, the main body 100 may be formed by placing sheets of magnetic material on the lower portion of the first coil 200 and the upper portion of the first coil 200, respectively, and then pressing and curing the same, and then placing thereon the second coil 300, and then a sheet of magnetic material, and then pressing and curing the same.

The first coil 200 and the second coil 300 are disposed inside the main body 100, exhibiting the characteristics of the coil electronic component. For example, when the coil electronic component 1000 of the present embodiment is utilized as a power inductor, when current is applied to the first coil 200 and the second coil 300, the coil electronic component may serve to stabilize the power source of an electronic device by storing energy in the form of a magnetic field and maintaining the output voltage.

The first coil 200 and the second coil 300 may be magnetically coupled to each other, thereby comprising a coupled inductor structure.

The first coil 200 may include at least one turn of a first conductive wire 210, and the second coil 300 may include at least one turn of a second conductive wire 310. For example, the first coil 200 and the second coil 300 may be in the form of spirally wound metal (for example, copper (Cu) or silver (Ag)) wire with a surface coated with an insulating material. That is, the first coil 200 and the second coil 300 may be wound coils. The first coil 200 and the second coil 300 are not limited to a single wire, and may comprise a twisted wire or two or more wires.

The first coil 200 and the second coil 300 may be circular coils, but are not limited thereto. For example, the first coil 200 and the second coil 300 may be various known coils, such as a rectangular coil or a race track shaped coil.

Referring to FIG. 4, a cross-section of the first conductive wire 210 of the first coil 200 and a cross-section of the second conductive wire 310 of the second coil 300 may each have a rectangular shape.

Here, the first conductive wire 210 of the first coil 200 may have a first coil surface 211, a second coil surface 212, a third coil surface 213, and a fourth coil surface 214. The first coil surface 211 and the second coil surface 212 oppose each other along the thickness direction (T-axis direction). The third coil surface 213 and the fourth coil surface 214 connect the first coil surface 211 and the second coil surface 212, and oppose each other along the length direction (L-axis direction).

The second conductive wire 310 of the second coil 300 may have a first coil surface 311, a second coil surface 312, a third coil surface 313, and a fourth coil surface 314. The first coil surface 311 and the second coil surface 312 oppose each other along the thickness direction (T-axis direction). The third coil surface 313 and the fourth coil surface 314 connect the first coil surface 311 and the second coil surface 312, and oppose each other along the length direction (L-axis direction).

The first coil 200 and the second coil 300 may each comprise a plurality of layers. The first coil 200 may include a lower coil 200A and an upper coil 200B. The upper coil 200B is connected to the lower coil 200A and is disposed on top of the lower coil 200A, that is, closer to the fifth surface S5 of the main body 100, to form layers. The second coil 300 may include a lower coil 300A and an upper coil 300B. The upper coil 300B is connected to the lower coil 300A and is disposed on top of the lower coil 300A, that is, closer to the fifth surface S5 of the main body 100, to form layers.

The first coil 200 and the second coil 300 may have a plurality of turns.

For example, the first coil 200 may have an outermost turn coil C1, at least one intermediate turn coil C2, and an innermost turn coil C3 sequentially inward from an outer surface of the main body 100.

Likewise, the second coil 300 may have an outermost turn coil C1′, at least one intermediate turn coil C2′, and an innermost turn coil C3′ sequentially inward from the outer surface of the main body 100.

Insulating films IF may be disposed along the respective surfaces of the first conductive wire 210 of the first coil 200 and the second conductive wire 310 of the second coil 300. The insulating film IF is for protecting and insulating the first conductive wire 210 of the first coil 200 and the second conductive wire 310 of the second coil 300, and may contain a well-known insulating material such as parylene. The insulating film IF may include any insulating material, and the insulating material of the insulating film IF is not particularly limited. For example, the insulating film IF may be a polyurethane resin, a polyester resin, an epoxy resin, or a polyamide-imide resin. The insulating film IF may be formed by a method such as vapor deposition, but is not limited thereto.

The first coil 200 may include a winding portion 220 and lead-out portions 230.

The winding portion 220 is a portion where the first conductive wire 210 comprises at least one turn.

The lead-out portions 230 extend from both ends of the winding portion 220, respectively, each of the lead-out portions 230 being exposed to the sixth surface S6 of the main body 100. The lead-out portions 230 include a first lead-out portion 233 and a second lead-out portion 235. The first lead-out portion 233 extends from one end of the winding portion 220 and is exposed to the sixth surface S6 of the main body 100, and the second lead-out portion 235 extends from the other end of the winding portion 220 and is exposed to the sixth surface S6 of the main body 100.

Meanwhile, the locations where the first lead-out portion 233 and the second lead-out portion 235 are exposed to the sixth surface S6 of the main body 100 may be spaced apart from each other in the length direction (L-axis direction), but are not limited thereto.

The second coil 300 may include a winding portion 320 and lead-out portions 330.

The winding portion 320 is a portion where the second conductive wire 310 comprises at least one turn.

The lead-out portions 330 extend from both ends of the winding portion 320, respectively, each of the lead-out portions 330 being exposed to the sixth surface S6 of the main body 100. The lead-out portions 330 include a first lead-out portion 333 and a second lead-out portion 335. The first lead-out portion 333 extends from one end of the winding portion 320 and is exposed to the sixth surface S6 of the main body 100, and the second lead-out portion 335 extends from the other end of the winding portion 320 and is exposed to the sixth surface S6 of the main body 100.

Meanwhile, the locations where the first lead-out portion 333 and the second lead-out portion 335 are exposed to the sixth surface S6 of the main body 100 may be spaced apart from each other in the length direction (L-axis direction), but are not limited thereto.

For example, the main body 100 may include a first magnetic body 101, a second magnetic body 102, and a third magnetic body 103.

The first magnetic body 101 may comprise a portion of the first surface S1, a portion of the second surface S2, a portion of the third surface S3, and a portion of the fourth surface S4 of the main body 100, and may comprise the sixth surface S6 of the main body 100. The first magnetic body 101 may surround most of the first coil 200 except for the portion of the first coil 200 that opposes the second coil 300.

The second magnetic body 102 may comprise another portion of the first surface S1, another portion of the second surface S2, another portion of the third surface S3, and another portion of the fourth surface S4 of the main body 100, and may comprise the fifth surface S5 of the main body 100. The second magnetic body 102 may surround most of the second coil 300 except for the portion of the second coil 300 that opposes the first coil 200.

The third magnetic body 103 may be disposed between the first coil 200 and the second coil 300, and hereinafter may be referred to as an “intermediate layer” as needed. For example, the third magnetic body 103 may be in contact with the first coil 200 and the second coil 300.

The third magnetic body 103 may be disposed to extend from a first region R1 between a first core 113 of the first coil 200 and a second core 123 of the second coil 300 to a second region R2 between the first coil 200 and the second coil 300. The third magnetic body 103 may also extend beyond the second region R2 to form a flush surface with the outer surface of the main body 100. For example, the third magnetic body 103 may be flush with the first surface S1 and the second surface S2 of the main body 100.

The first core 113 may be a region in which a first hollow space of the first coil 200 is at least partially filled with the first magnetic body 101, and the second core 123 may be a region in which a second hollow space of the second coil 300 is at least partially filled with the second magnetic body 102. That is, the first magnetic body 101 that fills the first hollow space of the first coil 200 may form the first core 113 around which the first coil 200 is wound, and the second magnetic body 102 that fills the second hollow space of the second coil 300 may form the second core 123 around which the second coil 300 is wound.

The third magnetic body 103 may extend from the first region R1 to a portion of the first core 113, or may extend from the first region R1 to a portion of the second core 123. Meanwhile, the third magnetic body 103 may extend from the first region R1 to a portion of the first core 113 and a portion of the second core 123.

When the third magnetic body 103 extends from the first region R1 to a portion of the first core 113, the portion of the first core 113 may be filled with the third magnetic body 103 and the remaining portion of the first core 113 may be filled with the first magnetic body 101. In addition, when the third magnetic body 103 extends from the first region R1 to a portion of the second core 123, the portion of the second core 123 may be filled with the third magnetic body 103 and the remaining portion of the second core 123 may be filled with the second magnetic body 102. In this case, the first magnetic body 101 and the third magnetic body 103 that fill the first hollow space of the first coil 200 may form the first core 113 around which the first coil 200 is wound, and the second magnetic body 102 and the third magnetic body 103 that fill the second hollow space of the second coil 300 may form the second core 123 around which the second coil 300 is wound.

Like the first magnetic body 101 and the second magnetic body 102, the third magnetic body 103 includes the aforementioned magnetic material, but a magnetic permeability of the third magnetic body 103 may be smaller or larger than the magnetic permeabilities of the first magnetic body 101 and the second magnetic body 102. Furthermore, the magnetic permeabilities of the first magnetic body 101 and the second magnetic body 102 and the magnetic permeability of the third magnetic body 103 may be set appropriately to adjust the coefficient of coupling (K) of the first coil 200 and the second coil 300.

For example, when the first magnetic body 101 and the second magnetic body 102 have the same magnetic permeability and include first magnetic particles, as a method of adjusting the magnetic permeability of the third magnetic body 103, a volume fraction of the first magnetic particles included in the first magnetic body 101 and the second magnetic body 102 and a volume fraction of the second magnetic particles included in the third magnetic body 103 may be set differently. Here, the volume fraction of the magnetic particles refers to a ratio of the volume of the first magnetic particles to the volume of the first magnetic body 101 and second magnetic body 102, or a ratio of the volume of the second magnetic particles to the volume of the third magnetic body 103. In order to adjust relative magnetic permeabilities of the first magnetic body 101 and second magnetic body 102 and the third magnetic body 103 based on the volume fractions of the first magnetic particles and the second magnetic particles, the first magnetic particles and the second magnetic particles may be realized as the same material, for example, a metal alloy of the same composition. Meanwhile, as a method of adjusting the magnetic permeabilities of the first magnetic body 101 and second magnetic body 102 and the third magnetic body 103, an area fraction of the first magnetic particles included in the first magnetic body 101 and the second magnetic body 102 and an area fraction of the second magnetic particles included in the third magnetic body 103 may be set differently when confirmed in cross-section. Here, the area fraction of magnetic particles refers to a ratio of the cross-sectional area of the first magnetic particles to the cross-sectional area of the first magnetic body 101 and second magnetic body 102, or a ratio of the cross-sectional area of the second magnetic particles to the cross-sectional area of the third magnetic body 103.

When the magnetic permeability of the third magnetic body 103 is greater than the magnetic permeability of the first magnetic body 101 and the second magnetic body 102, the volume fraction of the second magnetic particles included in the third magnetic body 103 is greater than the volume fraction of the first magnetic particles included in the first magnetic body 101 and the second magnetic body 102. If the magnetic permeability of the third magnetic body 103 is greater than the magnetic permeability of the first magnetic body 101 and the second magnetic body 102, the coefficient of coupling of the first coil 200 and the second coil 300 may relatively decrease. Here, a relative decrease in coefficient of coupling means that the coefficient of coupling becomes smaller compared with the case where the magnetic permeability of the third magnetic body 103 and the magnetic permeability of the first magnetic body 101 and the second magnetic body 102 are the same. When the magnetic permeability of the third magnetic body 103 is relatively large, an amount of magnetic flux flowing through the third magnetic body 103 is relatively large, and a mutual inductance caused by a magnetic flux shared by the first coil 200 and the second coil 300 becomes smaller. Here, the magnetic flux flowing through the third magnetic body 103 may be understood as magnetic flux flowing through the third magnetic body 103 in the length direction (L-axis direction) in FIG. 4.

As a result, the mutual inductance of the first coil 200 and the second coil 300 becomes smaller and the leakage inductance formed only in the first coil 200 or the second coil 300 becomes larger, so the coefficient of coupling of the first coil 200 and the second coil 300 becomes smaller.

On the other hand, when the magnetic permeability of the third magnetic body 103 is smaller than the magnetic permeability of the first magnetic body 101 and the second magnetic body 102, the volume fraction of the second magnetic particles included in the third magnetic body 103 is smaller than the volume fraction of the first magnetic particles included in the first magnetic body 101 and the second magnetic body 102. If the magnetic permeability of the third magnetic body 103 is smaller than the magnetic permeability of the first magnetic body 101 and the second magnetic body 102, the coefficient of coupling of the first coil 200 and the second coil 300 may relatively increase. Here, a relative increase in coefficient of coupling means that the coefficient of coupling becomes larger compared with the case where the magnetic permeability of the third magnetic body 103 and the magnetic permeability of the first magnetic body 101 and the second magnetic body 102 are the same. When the magnetic permeability of the third magnetic body 103 is relatively small, an amount of magnetic flux flowing through the third magnetic body 103 is relatively small, and a mutual inductance caused by a magnetic flux shared by the first coil 200 and the second coil 300 becomes larger. Here, the magnetic flux flowing through the third magnetic body 103 may be understood as magnetic flux flowing through the third magnetic body 103 in the length direction (L-axis direction) in FIG. 4.

As a result, the mutual inductance of the first coil 200 and the second coil 300 becomes larger and the leakage inductance formed only in the first coil 200 or the second coil 300 becomes smaller, so the coefficient of coupling of the first coil 200 and the second coil 300 becomes larger.

While the above description relates to the case where the first magnetic body 101 and the second magnetic body 102 have the same magnetic permeability and contain first magnetic particles, the description may similarly apply to the case where the first magnetic body 101 and the second magnetic body 102 have different magnetic permeabilities and the first magnetic body 101 and the second magnetic body 102 contain different magnetic particles.

The first external electrode 500 and the second external electrode 600 are disposed outside the main body 100 and electrically connected to the first coil 200.

The first external electrode 500 is disposed on the sixth surface S6 of the main body 100, and the first lead-out portion 233 of the first coil 200 is exposed from the sixth surface S6 of the main body 100 and connected to the first external electrode 500.

The second external electrode 600 is disposed on the sixth surface S6 of the main body 100, and the second lead-out portion 235 of the first coil 200 is exposed from the sixth surface S6 of the main body 100 and connected to the second external electrode 600.

The first external electrode 500 and the second external electrode 600 may each include a conductive material such as copper (Cu), aluminum (Al), silver (Ag), tin (Sn), gold (Au), nickel (Ni), lead (Pb), chromium (Cr), titanium (Ti), or an alloy thereof, but are not limited thereto.

The first external electrode 500 and the second external electrode 600 may include a plurality of metal layers formed by plating conductive metals.

Referring to the left circle in FIG. 1, the first external electrode 500 may include a first metal layer 501, a second metal layer 502, and a third metal layer 503.

The first metal layer 501 is a plating layer that is in contact with the first lead-out portion 233 of the first coil 200 and the outer surface of the main body 100, and may include copper (Cu). The second metal layer 502 is a plating layer that covers the first metal layer 501, and may include nickel (Ni). The third metal layer 503 is a plating layer that covers the second metal layer 502, and may include tin (Sn). However, the present embodiment is not limited to such a three-layer structure, and a two-layer structure with only one plating layer added onto the first metal layer 501 is also possible.

Referring to the right circle in FIG. 1, the second external electrode 600 may include a first metal layer 601, a second metal layer 602, and a third metal layer 603.

The first metal layer 601 is a plating layer that is in contact with the second lead-out portion 235 of the first coil 200 and the outer surface of the main body 100, and may include copper (Cu). The second metal layer 602 is a plating layer that covers the first metal layer 601, and may include nickel (Ni). The third metal layer 603 is a plating layer that covers the second metal layer 602, and may include tin (Sn). However, the present embodiment is not limited to such a three-layer structure, and a two-layer structure with only one plating layer added onto the first metal layer 601 is also possible.

In this manner, the first external electrode 500 and the second external electrode 600 may each include nickel (Ni), copper (Cu), palladium (Pd), gold (Au), or an alloy thereof, and may include a plurality of plating layers. For example, the first external electrode 500 and the second external electrode 600 may each be made of combinations such as a nickel (Ni) layer, a copper (Cu) layer, and a nickel/copper (Ni/Cu) layer (i.e., a metal layer in which a copper (Cu) layer is laminated on a nickel (Ni) layer), a palladium/nickel (Pd/Ni) layer (i.e., a metal layer in which a nickel (Ni) layer is laminated on a palladium (Pd) layer), a palladium/nickel/copper (Pd/Ni/Cu) layer (i.e., a metal layer in which a nickel (Ni) layer and a copper (Cu) layer are laminated sequentially in this order on a palladium (Pd) layer), and a copper/nickel/copper (Cu/Ni/Cu) layer (i.e., a metal layer in which a nickel (Ni) layer and a copper (Cu) layer are laminated sequentially in this order on a copper (Cu) layer).

In some cases, the outermost layer of the external electrode may be made of tin (Sn). Since the tin (Sn) plating layer has a relatively low melting point, it can improve the ease of substrate mounting of the first external electrode 500 and the second external electrode 600.

In general, the tin (Sn) plating layer may be bonded to an electrode pad on the substrate through a solder containing a tin (Sn)-copper (Cu)-silver (Ag) alloy paste. That is, the tin (Sn) plating layer can melt and bond with the solder during a heat treatment (reflow) process.

As another example, the first external electrode 500 and the second external electrode 600 may each include a plurality of electrode layers. For example, the first external electrode 500 and the second external electrode 600 may each include a first electrode layer, a second electrode layer that covers the first electrode layer, and a third electrode layer that covers the second electrode layer. The first electrode layer may include copper (Cu) and may be a conductive resin layer. The conductive resin layer may include a conductive metal for ensuring electrical conductivity and a resin for shock absorption. The resin is not particularly limited as long as it has bonding and shock absorbing properties and can be mixed with conductive metal powder to form a paste, and may include, for example, phenol resins, acrylic resins, silicone resins, epoxy resins, or polyimide resins. The conductive metal may include, for example, copper (Cu), tin (Sn), nickel (Ni), silver (Ag), palladium (Pd), gold (Au), platinum (Pt), tungsten (W), titanium (Ti), an alloy thereof, or a combination thereof. The third external electrode 700 and the fourth external electrode 800 are disposed outside the main body 100 and electrically connected to the second coil 300.

The third external electrode 700 is disposed on the sixth surface S6 of the main body 100, and the first lead-out portion 333 of the second coil 300 is exposed from the sixth surface S6 of the main body 100 and connected to the third external electrode 700.

The fourth external electrode 800 is disposed on the sixth surface S6 of the main body 100, and the second lead-out portion 335 of the second coil 300 is exposed from the sixth surface S6 of the main body 100 and connected to the fourth external electrode 800.

Since the structures and components of the third external electrode 700 and the fourth external electrode 800 are the same as those of the first external electrode 500 and second external electrode 600 described above, a redundant description thereof will be omitted.

Meanwhile, an insulating layer 900 may be disposed on the main body 100 of the coil electronic component 1000 according to the present embodiment, except for the areas where the first external electrode 500, the second external electrode 600, the third external electrode 700, and the fourth external electrode 800 are disposed. In contrast, an insulating layer may be present between the portion where the first lead-out portion 233 of the first coil 200 is exposed, the portion where the second lead-out portion 235 of the first coil 200 is exposed, the portion where the first lead-out portion 333 of the second coil 300 is exposed, and the portion where the second lead-out portion 335 of the second coil 300 is exposed on the sixth surface S6 of the main body 100. In this case, the first external electrode 500, the second external electrode 600, the third external electrode 700, and the fourth external electrode 800 may cover portions of the insulating layer.

As described above, the insulating layer 900 may be disposed on at least a portion of the first surface S1, the second surface S2, the third surface S3, the fourth surface S4, the fifth surface S5, and the sixth surface S6 of the main body 100 to prevent electrical short circuits between other electronic components and the external electrodes 500, 600, 700, and 800.

The insulating layer 900 may be utilized as a resist when forming the external electrodes 500, 600, 700, and 800 by electroplating, but is not limited thereto.

Meanwhile, the external electrodes 500, 600, 700, and 800 according to the present embodiment may have various shapes without being limited to the aforementioned shapes.

For example, the first external electrode 500 may be connected to the first lead-out portion 233 of the first coil 200 on the sixth surface S6 of the main body 100 and extend onto the first surface S1 of the main body 100. In addition, the second external electrode 600 may be connected to the second lead-out portion 235 of the first coil 200 on the sixth surface S6 of the main body 100 and extend onto the second surface S2 of the main body 100. The third external electrode 700 may be connected to the first lead-out portion 333 of the second coil 300 on the sixth surface S6 of the main body 100 and extend onto the first surface S1 of the main body 100. In addition, the fourth external electrode 800 may be connected to the second lead-out portion 335 of the second coil 300 on the sixth surface S6 of the main body 100 and extend onto the second surface S2 of the main body 100.

As another example, the first external electrode 500 may be connected to the first lead-out portion 233 of the first coil 200 on the sixth surface S6 of the main body 100 and extend onto the first surface S1 and the fifth surface S5 of the main body 100. In addition, the second external electrode 600 may be connected to the second lead-out portion 235 of the first coil 200 on the sixth surface S6 of the main body 100 and extend onto the second surface S2 and the fifth surface S5 of the main body 100. The third external electrode 700 may be connected to the first lead-out portion 333 of the second coil 300 on the sixth surface S6 of the main body 100 and extend onto the first surface S1 and the fifth surface S5 of the main body 100. In addition, the fourth external electrode 800 may be connected to the second lead-out portion 335 of the second coil 300 on the sixth surface S6 of the main body 100 and extend onto the second surface S2 and the fifth surface S5 of the main body 100.

When the length of the coil electronic component is constant, the larger the core width, the larger the area of the magnetic path, so the capacity can increase. In addition, as a size of the margin portion in the length direction (L-axis direction) of the magnetic body decreases, the capacity may increase. That is, if the size of the margin portion is reduced, the coil can be placed farther away from a center of the coil electronic component by that amount, resulting in a wider core and increased capacity. Meanwhile, as the number of turns of the conductive wire of the coil increases, the capacity can increase.

In the present embodiment, the number of turns of the coil may be adjusted by changing the thickness and width of the cross-section of the conductive wire while fixing the width of the core and the cross-sectional area of the conductive wire, or the width of the core may be adjusted by changing the thickness and width of the cross-section of the conductive wire while fixing the number of turns of the coil and the cross-sectional area of the conductive wire. This will be described in more detail below.

The cross-section of the first conductive wire 210 has a rectangular shape and may satisfy the following formula 1.

$$0 < w 1 \leq t 1 < T 1 / 2 \qquad [ Formula 1 ]$$

where,
t1: thickness of the cross-section of the first conductive wire
w1: width of the cross-section of the first conductive wire
T1: thickness of the main body

Additionally, w1 and t1 may satisfy the following ranges.

$$0.0075 \leq w 1 / L 1 \leq 0.02735 , 0.0548 \leq t 1 / T 1 \leq 0.2$$

where,
L1: length of the main body

For example, when the length of the main body is 2.000 mm and the thickness is 1.000 mm, w1 and t1 may satisfy the following ranges.

$$0.015 mm \leq w 1 \leq 0.0547 mm , 0.0548 mm \leq t 1 \leq 0.2 mm$$

Additionally, the cross-section of the second conductive wire 310 has a rectangular shape and may satisfy the following formula 2.

$$0 < w {1}^{′} \leq t {1}^{′} < T 1 / 2 \qquad [ Formula 2 ]$$

where,
t1′: thickness of the cross-section of the second conductive wire
w1′: width of the cross-section of the second conductive wire
T1: thickness of the main body

Additionally, w1′ and t1′ may satisfy the following ranges.

$$0.0075 \leq w {1}^{′} / L 1 \leq 0.02735 , 0.0548 \leq t {1}^{′} / T 1 \leq 0.2$$

where,
L1: length of the main body

For example, when the length of the main body is 2.000 mm and the thickness is 1.000 mm, w1′ and t1′ may satisfy the following ranges.

$$0.015 mm \leq w {1}^{′} \leq 0.0547 mm , 0.0548 mm \leq t {1}^{′} \leq 0.2 mm$$

The thickness and width of the cross-section of the first conductive wire 210 and the thickness and width of the cross-section of the second conductive wire 310 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 1000 in the width direction (W-axis direction).

For example, the thickness of each cross-section of the first conductive wire 210 (or the second conductive wire 310) may refer to a maximum value of lengths of a plurality of line segments each connecting two sides opposing each other in a first direction of the cross-section in the L-T cross-section photograph. Here, the first direction may be parallel to the thickness direction (T-axis direction) or may be a direction forming an angle of less than 45 degrees with the thickness direction (T-axis direction). In addition, the width of the cross-section of the first conductive wire 210 (or the second conductive wire 310) may refer to a maximum value of lengths of a plurality of line segments each connecting two sides opposing each other in a second direction of the cross-section in the L-T cross-section photograph. Here, the second direction may be parallel to the length direction (L-axis direction) or may be a direction forming an angle of less than 45 degrees with the length direction (L-axis direction). Furthermore, the thickness of the cross-section of the first conductive wire 210 (or the second conductive wire 310) may be an arithmetic average value of thicknesses of the cross-section of the first conductive wire 210 (or the second conductive wire 310) at three equally spaced points on the first conductive wire 210 (or the second conductive wire 310) of the outermost turn, in the L-T cross-section photograph. Meanwhile, the width of the cross-section of the first conductive wire 210 (or the second conductive wire 310) may be an arithmetic average value of widths of the cross-section of the first conductive wire 210 (or the second conductive wire 310) at three equally spaced points on the first conductive wire 210 (or the second conductive wire 310) of the outermost turn, in the L-T cross-section photograph. Other methods and/or tools appreciated by one of ordinary skill in the art, even if not described in the present disclosure, may also be used.

Additionally, a ratio of a sum of cross-sectional areas of the first coil 200 and the second coil 300 to a cross-sectional area of the main body 100 may be 0.048 or more and 0.2 or less.

The cross-sectional area of the first coil 200, the cross-sectional area of the second coil 300, and the cross-sectional area of the main body 100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 1000 in the width direction (W-axis direction).

For example, the cross-sectional area of the first coil 200, the cross-sectional area of the second coil 300, and the cross-sectional area of the main body 100 can be obtained by measuring the L-T cross-section photograph with a scanning electron microscope-energy dispersive X-ray spectroscopy (hereinafter referred to as “SEM-EDX”).

In another example, the cross-sectional area of the first coil 200 may be obtained by accurately measuring an area of each cross-section of the first conductive wire 210 shown in the L-T cross-section photograph using known image analysis software and then adding up all of these values. The cross-sectional area of the second coil 300 can also be obtained in the same manner.

Additionally, the cross-sectional area of the main body 100 shown in the L-T cross-section photograph can be accurately measured using known image analysis software. Other methods and/or tools appreciated by one of ordinary skill in the art, even if not described in the present disclosure, may also be used. Additionally, the number of turns of the first coil 200 may be 7.81 or more and 27.17 or less, and the number of turns of the second coil 300 may be 7.81 or more and 27.17 or less. For example, if the coil is wound in a circle and the radius of the core is r, then the length of the coil corresponding to one turn is 2 TTr, so dividing the total length of the coil by 2 TTr gives the total number of turns of the coil.

Meanwhile, the numbers of turns of the first coil 200 and the second coil 300 may be 4.5. In this case, a width d1 of the first core 113 of the first coil 200 may be 0.781 mm or more and 0.940 mm or less, and a width d2 of the second core 123 of the second coil 300 may be 0.781 mm or more and 0.940 mm or less. In addition, a value (d1/L1) obtained by dividing the width d1 of the first core 113 of the first coil 200 by a length L1 of the main body 100 may be 0.3905 or more and 0.47 or less, and a value (d2/L1) obtained by dividing the width d2 of the second core 123 of the second coil 300 by the length L1 of the main body 100 may be 0.3905 or more and 0.47 or less. In this case, the ratio of the sum of the cross-sectional areas of the first coil 200 and the second coil 300 to the cross-sectional area of the main body 100 may be 0.026.

The width d1 of the first core 113 of the first coil 200, the width d2 of the second core 123 of the second coil 300, and the length L1 of the main body 100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 1000 in the width direction (W-axis direction).

For example, the width of the first core 113 may be an arithmetic average value of widths of the first core 113 at five equally spaced points along the thickness direction (T-axis direction) in the L-T cross-section photograph. The width of the second core 123 can also be obtained in the same manner. Other methods and/or tools appreciated by one of ordinary skill in the art, even if not described in the present disclosure, may also be used.

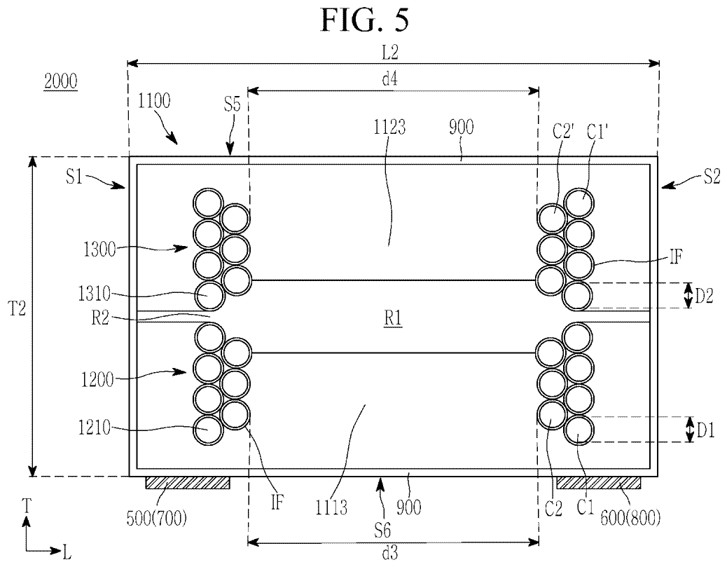

FIG. 5 is a cross-sectional view schematically showing a coil electronic component according to another embodiment.

Referring to FIG. 5, a coil electronic component 2000 includes a main body 1100, a first coil 1200, a second coil 1300, a first external electrode 500, a second external electrode 600, a third external electrode 700, and a fourth external electrode 800.

The first coil 1200 may include at least one turn of a first conductive wire 1210, and the second coil 1300 may include at least one turn of a second conductive wire 1310.

A cross-section of the first conductive wire 1210 has a circular shape and may satisfy the following formula 3.

$$0 < D 1 < L 2 / 2 \qquad [ Formula 3 ]$$

where,
D1: diameter of the cross-section of the first conductive wire
L2: length of the main body

Additionally, a cross-section of the second conductive wire 1310 has a circular shape and may satisfy the following formula 4.

$$0 < D 2 < L 2 / 2 \qquad [ Formula 4 ]$$

where,
D2: diameter of the cross-section of the second conductive wire
L2: length of the main body

The diameter D1 of the cross-section of the first conductive wire 1210, the diameter D2 of the cross-section of the second conductive wire 1310, and the length L2 of the main body 1100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 2000 in the width direction (W-axis direction).

For example, the diameter of the cross-section of the first conductive wire 1210 (or the second conductive wire 1310) may be an arithmetic average value of diameters of the cross-section of the first conductive wire 1210 (or second conductive wire 1310) on the lowest side, the center, and the uppermost side in the thickness direction (T-axis direction) at the outermost turn (C1 or C1′) in the L-T cross-section photograph. Other methods and/or tools appreciated by one of ordinary skill in the art, even if not described in the present disclosure, may also be used.

Additionally, a ratio of a sum of cross-sectional areas of the first coil 1200 and the second coil 1300 to a cross-sectional area of the main body 1100 may be 0.012 or more and 0.151 or less.

The cross-sectional area of the first coil 1200, the cross-sectional area of the second coil 1300, and the cross-sectional area of the main body 1100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 2000 in the width direction (W-axis direction).

For example, the cross-sectional area of the first coil 1200, the cross-sectional area of the second coil 1300, and the cross-sectional area of the main body 1100 can be obtained by measuring the L-T cross-section photograph with SEM-EDX.

In another example, the cross-sectional area of the first coil 1200 may be obtained by accurately measuring an area of each cross-section of the first conductive wire 1210 shown in the L-T cross section photograph with known image analysis software and then adding up all of these values. The cross-sectional area of the second coil 1300 can also be obtained in the same manner.

Additionally, the cross-sectional area of the main body 1100 shown in the L-T cross-section photograph can be accurately measured using known image analysis software. Other methods and/or tools appreciated by one of ordinary skill in the art, even if not described in the present disclosure, may also be used.

Additionally, the number of turns of the first coil 1200 may be 2.5 or more and 23.2 or less, and the number of turns of the second coil 1300 may be 2.5 or more and 23.2 or less.

In addition, D1 and D2 may each satisfy the following ranges.

$$0.0088 \leq D 1 / L 2 \leq 0.1 , 0.0088 \leq D 2 / L 2 \leq 0.1 \\ 0.0176 \leq D 1 / T 2 \leq 0.2 , 0.0176 < D 2 / T 2 \leq 0.2$$

where,
L2: length of the main body
T2: thickness of the main body

For example, when the length of the main body is 2.000 mm and the thickness is 1.000 mm, D1 and D2 may each satisfy the following ranges.

$$0.0176 mm \leq D 1 \leq 0.2 mm , 0.0176 mm \leq D 2 \leq 0.2 mm$$

Meanwhile, the numbers of turns of the first coil 1200 and the second coil 1300 may be 4.5. In this case, a width d3 of the first core 1113 of the first coil 1200 may be 0.2 mm or more and 0.957 mm or less, and a width d4 of the second core 1123 of the second coil 1300 may be 0.2 mm or more and 0.957 mm or less. In addition, a value (d3/L2) obtained by dividing the width d3 of the first core 1113 of the first coil 1200 by a length L2 of the main body 1100 may be 0.1 or more and 0.4785 or less, and a value (d4/L2) obtained by dividing the width d4 of the second core 1123 of the second coil 1300 by the length L2 of the main body 1100 may be 0.1 or more and 0.4785 or less. In this case, a ratio of a sum of cross-sectional areas of the first coil 1200 and the second coil 1300 to a cross-sectional area of the main body 1100 may be 0.001 or more and 0.354 or less.

The width d3 of the first core 1113 of the first coil 1200, the width d4 of the second core 1123 of the second coil 1300, and the length L2 of the main body 1100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 2000 in the width direction (W-axis direction).

For example, the width of the first core 1113 may be an arithmetic average value of widths of the first core 1113 at five equally spaced points along the thickness direction (T-axis direction) in the L-T cross-section photograph. The width of the second core 1123 can also be obtained in the same manner. Other methods and/or tools appreciated by one of ordinary skill in the art, even if not described in the present disclosure, may also be used.

With the exception of the above, the remaining components are the same as or correspond to the components of the coil electronic component shown in FIG. 1, so redundant descriptions thereof will be omitted.

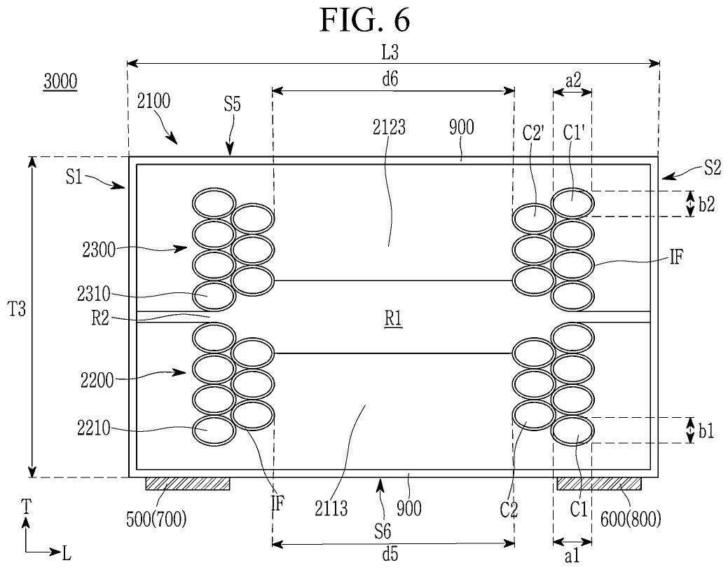

FIG. 6 is a cross-sectional view schematically showing a coil electronic component according to still another embodiment.

Referring to FIG. 6, a coil electronic component 3000 includes a main body 2100, a first coil 2200, a second coil 2300, a first external electrode 500, a second external electrode 600, a third external electrode 700, and a fourth external electrode 800.

The first coil 2200 may include at least one turn of a first conductive wire 2210, and the second coil 2300 may include at least one turn of a second conductive wire 2310.

A cross-section of the first conductive wire 2210 has an elliptical shape and may satisfy the following formula 5.

$$0 < b 1 < a 1 < L 3 / 2 \qquad [ Formula 5 ]$$

where,
a1: length of a major axis of the cross-section of the first conductive wire
b1: length of a minor axis of the cross-section of the first conductive wire
L3: length of the main body Additionally, a cross-section of the second conductive wire 2310 has an elliptical shape and may satisfy the following formula 6.

$$0 < b 2 < a 2 < L 3 / 2 \qquad [ Formula 6 ]$$

where,
a2: length of a major axis of the cross-section of the second conductive wire
b2: length of a minor axis of the cross-section of the second conductive wire
L3: length of the main body

The length a1 of the major axis and the length b1 of the minor axis of the cross-section of the first conductive wire 2210, the length a2 of the major axis and the length b2 of the minor axis of the cross-section of the second conductive wire 2310, and the length L3 of the main body 2100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 3000 in the width direction (W-axis direction).

For example, the length of the minor axis of each cross-section of the first conductive wire 2210 (or the second conductive wire 2310) may be an arithmetic average value of lengths of minor axes of the cross-section of the first conductive wire 2210 (or second conductive wire 2310) on the lowest side, the center and the uppermost side in the thickness direction (T-axis direction) at the outermost turn (C1 or C1′) in the L-T cross-section photograph. In addition, the length of the major axis of each cross-section of the first conductive wire 2210 (or the second conductive wire 2310) may be an arithmetic average value of lengths of major axes of the cross-section of the first conductive wire 2210 (or second conductive wire 2310) on the lowest side, the center and the uppermost side in the thickness direction (T-axis direction) at the outermost turn (C1 or C1′) in the L-T cross-section photograph. Other methods and/or tools appreciated by one of ordinary skill in the art, even if not described in the present disclosure, may also be used.

Additionally, a ratio of a sum of the cross-sectional areas of the first coil 2200 and the second coil 2300 to a cross-sectional area of the main body 2100 may be 0.0202.

The cross-sectional area of the first coil 2200, the cross-sectional area of the second coil 2300, and the cross-sectional area of the main body 2100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 3000 in the width direction (W-axis direction).

For example, the cross-sectional area of the first coil 2200, the cross-sectional area of the second coil 2300, and the cross-sectional area of the main body 2100 can be obtained by measuring the L-T cross-section photograph with SEM-EDX.

In another example, the cross-sectional area of the first coil 2200 may be obtained by accurately measuring an area of each cross-section of the first conductive wire 2210 shown in the L-T cross-section photograph with known image analysis software and then adding up all of these values. The cross-sectional area of the second coil 2300 can also be obtained in the same manner.

Additionally, the cross-sectional area of the main body 2100 shown in the L-T cross-section photograph can be accurately measured using known image analysis software. Other methods and/or tools appreciated by one of ordinary skill in the art, even if not described in the present disclosure, may also be used. Additionally, in this case, the number of turns of the first coil 2200 may be 1.8 or more and 11.9 or less, and the number of turns of the second coil 2300 may be 1.8 or more and 11.9 or less. In addition, in this case, a1, b1, a2, and b2 may satisfy the following ranges, respectively.

$$0.00175 \leq a 1 / L 3 \leq 0.15 , b 1 / T 3 = 0.03 \\ 0.00175 \leq a 2 / L 3 \leq 0.15 , b 2 / T 3 = 0.03$$

where,
L3: length of the main body
T3: thickness of the main body

For example, when the length of the main body is 2.000 mm and the thickness is 1.000 mm, a1, b1, a2, and b2 may each satisfy the following ranges.

$$\begin{matrix}0.035 mm \leq a 1 \leq 0.3 \; 00 mm , b 1 = 0.03 mm \\ 0.035 mm \leq a 2 \leq 0.3 \; 00 mm , b 2 = 0.0 \; 30 mm\end{matrix}$$

Meanwhile, the number of turns of the first core 2113 of the first coil 2200 may be 4.5. In this case, a width d5 of the first core 2113 of the first coil 2200 may be 0.2 mm or more and 0.86 mm or less, and a width d6 of the second core 2123 of the second coil 2300 may be 0.2 mm or more and 0.86 mm or less. In addition, a value (d5/L3) obtained by dividing the width d5 of the first core 2113 of the first coil 2200 by a length L3 of the main body 2100 may be 0.1 or more and 0.43 or less, and a value (d6/L3) obtained by dividing the width d6 of the second core 2123 of the second coil 2300 by the length L3 of the main body 2100 may be 0.1 or more and 0.43 or less. Additionally, in this case, the ratio of the sum of cross-sectional areas of the first coil 2200 and the second coil 2300 to the cross-sectional area of the main body 2100 may be 0.007 or more and 0.0412 or less. In this case, a1, b1, a2, and b2 may satisfy the following ranges, respectively.

$$\begin{matrix}0.0175 \leq a 1 / L 3 \leq 0.100 , b 1 / T 3 = 0.030 \\ 0.0175 \leq a 2 / L 3 \leq 0.100 , b 2 / T 3 = 0.030\end{matrix}$$

where,
L3: length of the main body
T3: thickness of the main body

For example, when the length of the main body is 2.000 mm and the thickness is 1.000 mm, a1, b1, a2, and b2 may satisfy the following ranges, respectively.

$$\begin{matrix}0.035 mm \leq a 1 \leq 0.2 mm , b 1 = 0.03 mm \\ 0.035 mm \leq a 2 \leq 0.2 mm , b 2 = 0.0 \; 30 mm\end{matrix}$$

The width d5 of the first core 2113 of the first coil 2200, the width d6 of the second core 2123 of the second coil 2300, and the length L3 of the main body 2100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 3000 in the width direction (W-axis direction).

For example, the width of the first core 2113 may be an arithmetic average value of widths of the first core 2113 at five equally spaced points along the thickness direction (T-axis direction) in the L-T cross-section photograph. The width of the second core 2123 can also be obtained in the same manner. Other methods and/or tools appreciated by one of ordinary skill in the art, even if not described in the present disclosure, may also be used.

With the exception of the above, the remaining components are the same as the components of the coil electronic component shown in FIG. 1, so redundant descriptions thereof will be omitted.

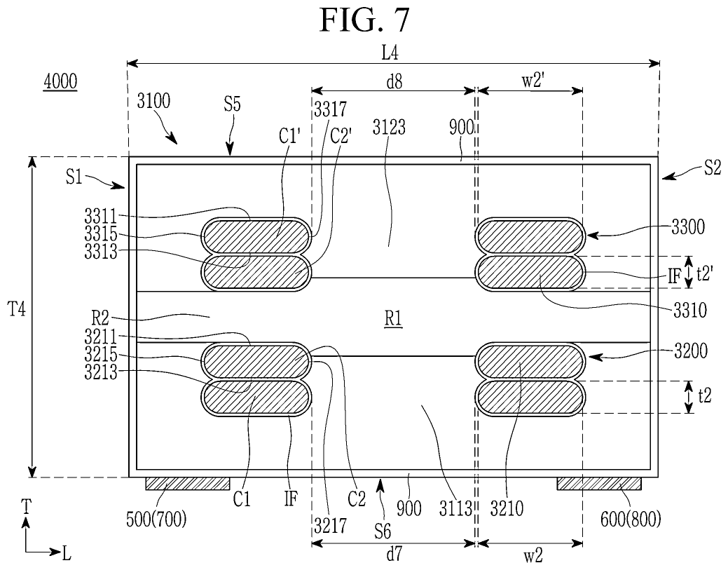

FIG. 7 is a cross-sectional view schematically showing a coil electronic component according to yet another embodiment.

Referring to FIG. 7, a coil electronic component 4000 includes a main body 3100, a first coil 3200, a second coil 3300, a first external electrode 500, a second external electrode 600, a third external electrode 700, and a fourth external electrode 800.

The first coil 3200 may include at least one turn of a first conductive wire 3210, and the second coil 3300 may include at least one turn of a second conductive wire 3310.

The first coil 3200 and the second coil 3300 have a plurality of turns, and may be edgewise coils.

For example, the first coil 3200 may have an outermost turn coil C1 and an innermost turn coil C2 sequentially in a direction from the sixth surface S6 to the fifth surface S5 of the main body 3100. Meanwhile, although not shown, at least one intermediate turn coil may be disposed between the outermost turn coil C1 and the innermost turn coil C2.

Similarly, the second coil 3300 may have an outermost turn coil C1′ and an innermost turn coil C2′ sequentially in a direction from the fifth surface S5 to the sixth surface S6 of the main body 3100. Meanwhile, although not shown, at least one intermediate turn coil may be disposed between the outermost turn coil C1′ and the innermost turn coil C2′.

A cross-section of the first conductive wire 3210 includes a first opposing portion 3211 and a second opposing portion 3213 that oppose each other, and a first curved portion 3215 and a second curved portion 3217 that connect the first opposing portion 3211 and the second opposing portion 3213, and may satisfy the following formula 7.

$$0 < t 2 < w 2 < L 4 / 2 \qquad [ Formula 7 ]$$

where,
t2: thickness of the cross-section of the first conductive wire
w2: width of the cross-section of the first conductive wire
L4: length of the main body

The first opposing portion 3211 and the second opposing portion 3213 may oppose each other in the thickness direction (T-axis direction). The first opposing portion 3211 and the second opposing portion 3213 may have a straight line shape.

The first curved portion 3215 and the second curved portion 3217 may oppose each other in the thickness direction (T-axis direction), and connect the first opposing portion 3211 and the second opposing portion 3213. That is, the left end (based on FIG. 7) of the first opposing portion 3211 and the left end (based on FIG. 7) of the second opposing portion 3213 are connected by the first curved portion 3215, and the right end (based on FIG. 7) of the first opposing portion 3211 and the right end (based on FIG. 7) of the second opposing portion 3213 are connected by the second curved portion 3217. The first curved portion 3215 and the second curved portion 3217 have a curved shape and have a convex shape in the length direction (L-axis direction), respectively. For example, radii of curvature of the first curved portion 3215 and the second curved portion 3317 may be ½ of the thickness of the first conductive wire 3210.

In addition, a cross-section of the second conductive wire 3310 includes a first opposing portion 3311 and a second opposing portion 3313 that oppose each other, and a first curved portion 3315 and a second curved portion 3317 that connect the first opposing portion 3311 and the second opposing portion 3313, and may satisfy the following formula 8.

$$0 < t {2}^{′} < w {2}^{′} < L 4 / 2 \qquad [ Formula 8 ]$$

where,
t2′: thickness of the cross-section of the second conductive wire
w2′: width of the cross-section of the second conductive wire
L4: length of the main body

The first opposing portion 3311 and the second opposing portion 3313 may oppose each other in the thickness direction (T-axis direction). The first opposing portion 3311 and the second opposing portion 3313 may have a straight line shape.

The first curved portion 3315 and the second curved portion 3317 may oppose each other in the length direction (L-axis direction), and connect the first opposing portion 3311 and the second opposing portion 3313. That is, the left end (based on FIG. 7) of the first opposing portion 3311 and the left end (based on FIG. 7) of the second opposing portion 3313 are connected by the first curved portion 3315, and the right end (based on FIG. 7) of the first opposing portion 3311 and the right end (based on FIG. 7) of the second opposing portion 3313 are connected by the second curved portion 3317. The first curved portion 3315 and the second curved portion 3317 have a curved shape and have a convex shape in the length direction (L-axis direction), respectively. For example, radii of curvature of the first curved portion 3315 and the second curved portion 3317 may be ½ of the thickness of the second conductive wire 3310.

The thickness and width of the cross-section of the first conductive wire 3210, the thickness and width of the cross-section of the second conductive wire 3310, and the length L4 of the main body 3100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 4000 in the width direction (W-axis direction).

For example, the thickness of each cross-section of the first conductive wire 3210 (or the second conductive wire 3310) may refer to a maximum value of distances between the first opposing portion and the second opposing portion of the cross-section in the L-T cross-section photograph. In addition, the width of the cross-section of the first conductive wire 3210 (or the second conductive wire 3310) may refer to a maximum value of distances between the first curved portion and the second curved portion of the cross-section in the L-T cross-section photograph. Furthermore, the thickness of the cross-section of the first conductive wire 3210 (or the second conductive wire 3310) may be an arithmetic average value of thicknesses of the cross-section of the first conductive wire 3210 (or the second conductive wire 3310) at three equally spaced points on the first conductive wire 3210 (or the second conductive wire 3310) of the outermost turn, in the L-T cross-section photograph. Meanwhile, the width of the cross-section of the first conductive wire 3210 (or the second conductive wire 3310) may be an arithmetic average value of widths of the cross-section of the first conductive wire 3210 (or the second conductive wire 3310) at three equally spaced points on the first conductive wire 3210 (or the second conductive wire 3310) of the outermost turn, in the L-T cross-section photograph.

In another example, the thickness of the cross-section of the first conductive wire 3210 (or the second conductive wire 3310) may refer to an arithmetic average value of a maximum value and a minimum value of distances between the first opposing portion and the second opposing portion of the cross-section in the L-T cross-section photograph, and the width of the cross-section of the first conductive wire 3210 (or the second conductive wire 3310) may refer to an arithmetic average value of a maximum value and a minimum value of distances between the first curved portion and the second curved portion of the cross-section in the L-T cross-section photograph.

In yet another example, the thickness of the cross-section of the first conductive wire 3210 (or the second conductive wire 3310) may refer to an arithmetic average value of thicknesses of the cross-section at three equally spaced points on the first opposing portion (or second opposing portion) of the cross-section in the L-T cross-section photograph. The three points may not include both ends of the first opposing portion (or the second opposing portion) in the length direction (L-axis direction). The width of the cross-section of the first conductive wire 3210 (or the second conductive wire 3310) may refer to a distance between a first straight line passing through a local maximum point of the first curved portion and a second straight line passing through a local maximum point of the second curved portion and parallel to the first straight line in the L-T cross-section photograph. Other methods and/or tools appreciated by one of ordinary skill in the art, even if not described in the present disclosure, may also be used.

Additionally, a ratio of a sum of cross-sectional areas of the first coil 3200 and the second coil 3300 to a cross-sectional area of the main body 3100 may be 0.0208 or more and 0.0245 or less. Here, the number of turns of the first coil 3200 may be 1.8 or more and 11.9 or less, and the number of turns of the second coil 3300 may be 1.8 or more and 11.9 or less. In addition, w2, t2, w2′, and t2′ may satisfy the following ranges, respectively.

$$\begin{matrix}0.0175 \leq w 2 / L 4 \leq 0.150 , t 2 / T 4 = 0.030 \\ 0.0175 \leq w {2}^{′} / L 4 \leq 0.150 , t {2}^{′} / T 4 = 0.030\end{matrix}$$

where,
L4: length of the main body
T4: thickness of the main body

For example, when the length of the main body is 2.000 mm and the thickness is 1.000 mm, w2, t2, w2′, and t2′ may satisfy the following ranges, respectively.

$$\begin{matrix}0.035 mm \leq w 1 \leq 0.3 mm , t 1 = 0.03 mm \\ 0.035 mm \leq w {2}^{′} \leq 0.3 mm , t {2}^{′} = 0. 0 \; 30 mm\end{matrix}$$

Meanwhile the numbers of turns of the first coil 3200 and the second coil 3300 may be 4.5. In this case, a width d7 of the first core 3113 of the first coil 3200 may be 0.2 mm or more and 0.86 mm or less, and a width d8 of the second core 3123 of the second coil 3300 may be 0.2 mm or more and 0.86 mm or less. In addition, a value (d7/L4) obtained by dividing the width d7 of the first core 3113 of the first coil 3200 by a length L4 of the main body 3100 may be 0.1 or more and 0.43 or less, and a value (d8/L4) obtained by dividing the width d8 of the second core 3123 of the second coil 3300 by the length L4 of the main body 3100 may be 0.1 or more and 0.43 or less. Here, a ratio of a sum of cross-sectional areas of the first coil 3200 and the second coil 3300 to a cross-sectional area of the main body 3100 may be 0.0072 or more and 0.0503 or less. In addition, w2, t2, w2′, and t2′ may satisfy the following ranges, respectively.

$$\begin{matrix}0.0175 \leq w 2 / L 4 \leq 0.1 , t 1 / T 4 = 0.03 \\ 0.0175 \leq w {2}^{′} / L 4 \leq 0.1 , t {2}^{′} / T 4 = 0.03\end{matrix}$$

where,
L4: length of the main body
T4: thickness of the main body

For example, when the length of the main body is 2.000 mm and the thickness is 1.000 mm, w2, t2, w2′, and t2′ may each satisfy the following ranges.

$$\begin{matrix}0.035 mm \leq w 2 \leq 0.2 mm , t 2 = 0.03 mm \\ 0.035 mm \leq w {2}^{′} \leq 0.2 mm , t {2}^{′} = 0. 0 \; 30 mm\end{matrix}$$

The cross-sectional area of the first coil 3200, the cross-sectional area of the second coil 3300, and the cross-sectional area of the main body 3100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 4000 in the width direction (W-axis direction).

For example, the cross-sectional area of the first coil 3200, the cross-sectional area of the second coil 3300, and the cross-sectional area of the main body 3100 can be obtained by measuring the L-T cross-section photograph with SEM-EDX.

In another example, the cross-sectional area of the first coil 3200 may be obtained by accurately measuring an area of each cross-section of the first conductive wire 3210 shown in the L-T cross-section photograph with known image analysis software and then adding up all of these values. The cross-sectional area of the second coil 3300 can also be obtained in the same manner.

Additionally, the cross-sectional area of the main body 3100 shown in the L-T cross-section photograph can be accurately measured using known image analysis software. Other methods and/or tools appreciated by one of ordinary skill in the art, even if not described in the present disclosure, may also be used.

The width d7 of the first core 3113 of the first coil 3200, the width d8 of the second core 3123 of the second coil 3300, and the length L4 of the main body 3100 are measured based on an optical microscope or scanning electron microscope (SEM) photograph of a cross-section (hereinafter, referred to as “L-T cross-section”) taken in the length direction (L-axis direction) and the thickness direction (T-axis direction) perpendicularly to the width direction (W-axis direction) at a central portion of the coil electronic component 3000 in the width direction (W-axis direction). Other methods and/or tools appreciated by one of ordinary skill in the art, even if not described in the present disclosure, may also be used. With the exception of the above, the remaining components are the same as those of the coil electronic component shown in FIG. 1, so redundant descriptions thereof will be omitted.

Below, specific examples of the present disclosure are presented. However, the examples described below are only for illustrating or describing the present disclosure in detail and should not be construed as limiting the scope of the present disclosure.

### Preparation Example 1: Manufacture of Coil Electronic Components

Coil electronic components according to Examples 1 to 18 and Comparative Examples 1 to 8 were prepared by forming a two-layered lower coil and a two-layered upper coil with conductive wires having a rectangular cross-sectional shape.

Specific numerical values regarding the cross-section of the conductive wire, the coil, and the main body of the prepared coil electronic components are shown in Table 1. Meanwhile, the length, thickness, and width of the main body are 2.000 mm, 1.000 mm, and 1.200 mm, respectively, the thickness of the intermediate layer is 0.200 mm, the margin in the length direction (L-axis direction) is 0.100 mm, and the margin in the width direction (W-axis direction) is 0.500 mm.

TABLE 1

| | | | | Coils | | | Main body | |
|---|---|---|---|---|---|---|---|---|
| | Cross-section of | | | | Cross- | | | Cross- |
| | conductive wire | | | | sectional | Turn | Core | sectional |
| | Width | Thickness | Area | Number | area | width | width | area |
| | (mm) | (mm) | (mm²) | of turns | (mm²) | (mm) | (mm) | (mm²) |
| Comparative | 0.0549 | 0.0546 | 0.003 | 7.79 | 0.0437 | 0.200 | 0.600 | 0.9163 |
| Example 1 | | | | | | | | |
| Comparative | 0.0548 | 0.0547 | 0.003 | 7.80 | 0.0438 | 0.200 | 0.600 | 0.9162 |
| Example 2 | | | | | | | | |
| Example 1 | 0.0547 | 0.0548 | 0.003 | 7.81 | 0.0439 | 0.200 | 0.600 | 0.9161 |
| Example 2 | 0.0500 | 0.0600 | 0.003 | 8.50 | 0.0480 | 0.200 | 0.600 | 0.9120 |
| Example 3 | 0.0450 | 0.0670 | 0.003 | 9.39 | 0.0530 | 0.200 | 0.600 | 0.9067 |
| Example 4 | 0.0400 | 0.0750 | 0.003 | 10.50 | 0.0600 | 0.200 | 0.600 | 0.9000 |
| Example 5 | 0.0350 | 0.0860 | 0.003 | 11.93 | 0.0690 | 0.200 | 0.600 | 0.8914 |
| Example 6 | 0.0300 | 0.1000 | 0.003 | 13.83 | 0.0800 | 0.200 | 0.600 | 0.8800 |
| Example 7 | 0.0250 | 0.1200 | 0.003 | 16.50 | 0.0960 | 0.200 | 0.600 | 0.8640 |
| Example 8 | 0.0200 | 0.1500 | 0.003 | 20.50 | 0.1200 | 0.200 | 0.600 | 0.8400 |
| Example 9 | 0.0150 | 0.2000 | 0.003 | 27.17 | 0.1600 | 0.200 | 0.600 | 0.8000 |
| Comparative | 0.0120 | 0.2500 | 0.003 | 33.8 | 0.2000 | 0.200 | 0.600 | 0.7600 |
| Example 3 | | | | | | | | |
| Comparative | 0.0100 | 0.3000 | 0.003 | 40.5 | 0.2400 | 0.200 | 0.600 | 0.7200 |
| Example 4 | | | | | | | | |
| Comparative | 0.0549 | 0.0546 | 0.003 | 4.5 | 0.0240 | 0.110 | 0.780 | 0.936 |
| Example 5 | | | | | | | | |
| Comparative | 0.0548 | 0.0547 | 0.003 | 4.5 | 0.0240 | 0.110 | 0.781 | 0.936 |
| Example 6 | | | | | | | | |
| Example 10 | 0.0547 | 0.0548 | 0.003 | 4.5 | 0.0240 | 0.109 | 0.781 | 0.936 |
| Example 11 | 0.0500 | 0.0600 | 0.003 | 4.5 | 0.0240 | 0.100 | 0.800 | 0.936 |
| Example 12 | 0.0450 | 0.0670 | 0.003 | 4.5 | 0.0240 | 0.090 | 0.820 | 0.936 |
| Example 13 | 0.0400 | 0.0750 | 0.003 | 4.5 | 0.0240 | 0.080 | 0.840 | 0.936 |
| Example 14 | 0.0350 | 0.0860 | 0.003 | 4.5 | 0.0240 | 0.070 | 0.860 | 0.936 |
| Example 15 | 0.0300 | 0.1000 | 0.003 | 4.5 | 0.0240 | 0.060 | 0.880 | 0.936 |
| Example 16 | 0.0250 | 0.1200 | 0.003 | 4.5 | 0.0240 | 0.050 | 0.900 | 0.936 |
| Example 17 | 0.0200 | 0.1500 | 0.003 | 4.5 | 0.0240 | 0.040 | 0.920 | 0.936 |
| Example 18 | 0.0150 | 0.2000 | 0.003 | 4.5 | 0.0240 | 0.030 | 0.940 | 0.936 |
| Comparative | 0.0120 | 0.2500 | 0.003 | 4.5 | 0.0240 | 0.020 | 0.950 | 0.936 |
| Example 7 | | | | | | | | |
| Comparative | 0.0100 | 0.3000 | 0.003 | 4.5 | 0.0240 | 0.020 | 0.960 | 0.936 |
| Example 8 | | | | | | | | |

The turn width of the coil refers to the width of the cross-section of the coil disposed between the core and the first surface (or second surface) of the main body. The turn width is for a one coil.

The cross-sectional area of the main body refers to the cross-sectional area occupied by the magnetic body excluding the coils.

### Preparation Example 2: Manufacture of Coil Electronic Components

Coil electronic components according to Examples 19 to 34 and Comparative Examples 9 to 16 were prepared by forming a two-layered lower coil and a two-layered upper coil using conductive wires having a circular cross-sectional shape.

Specific numerical values regarding the cross-section of the conductive wire, the coil, and the main body of the prepared coil electronic components are shown in Table 2. Meanwhile, the length, thickness, and width of the main body are 2.000 mm, 1.000 mm, and 1.200 mm, respectively, the thickness of the intermediate layer is 0.200 mm, the margin in the length direction (L-axis direction) is 0.100 mm, and the margin in the width direction (W-axis direction) is 0.500 mm.

TABLE 2

| | | | Coils | | | Main body | |
|---|---|---|---|---|---|---|---|
| | Cross-section of | | | Cross- | | | Cross- |
| | conductive wire | | | sectional | Turn | Core | sectional |
| | Diameter | Area | Number | area | width | width | area |
| | (mm) | (mm²) | of turns | (mm²) | (mm) | (mm) | (mm²) |
| Comparative | 0.0100 | 0.0001 | 40.5 | 0.006 | 0.2 | 0.6 | 0.954 |
| Example 9 | | | | | | | |
| Comparative | 0.0175 | 0.0002 | 23.4 | 0.0110 | 0.2 | 0.6 | 0.9490 |
| Example 10 | | | | | | | |
| Example 19 | 0.0176 | 0.0002 | 23.2 | 0.0111 | 0.2 | 0.6 | 0.9489 |
| Example 20 | 0.0200 | 0.0003 | 20.5 | 0.013 | 0.2 | 0.6 | 0.947 |
| Example 21 | 0.0300 | 0.0007 | 13.8 | 0.019 | 0.2 | 0.6 | 0.941 |
| Example 22 | 0.0400 | 0.0013 | 10.5 | 0.025 | 0.2 | 0.6 | 0.935 |
| Example 23 | 0.0500 | 0.0020 | 8.5 | 0.031 | 0.2 | 0.6 | 0.929 |
| Example 24 | 0.1000 | 0.0079 | 4.5 | 0.063 | 0.2 | 0.6 | 0.897 |
| Example 25 | 0.1500 | 0.0177 | 3.2 | 0.094 | 0.2 | 0.6 | 0.866 |
| Example 26 | 0.2000 | 0.0314 | 2.5 | 0.126 | 0.2 | 0.6 | 0.834 |
| Comparative | 0.2500 | 0.0491 | 2.1 | 0.157 | 0.2 | 0.6 | 0.803 |
| Example 11 | | | | | | | |
| Comparative | 0.3000 | 0.0707 | 1.8 | 0.188 | 0.2 | 0.6 | 0.772 |
| Example 12 | | | | | | | |
| Comparative | 0.0100 | 0.0001 | 4.5 | 0.0006 | 0.020 | 0.960 | 0.9594 |
| Example 13 | | | | | | | |
| Comparative | 0.0108 | 0.0001 | 4.5 | 0.0007 | 0.022 | 0.957 | 0.9593 |
| Example 14 | | | | | | | |
| Example 27 | 0.0109 | 0.0001 | 4.5 | 0.0007 | 0.022 | 0.957 | 0.9593 |
| Example 28 | 0.0200 | 0.0003 | 4.5 | 0.003 | 0.04 | 0.92 | 0.957 |
| Example 29 | 0.0300 | 0.0007 | 4.5 | 0.006 | 0.06 | 0.88 | 0.954 |
| Example 30 | 0.0400 | 0.0013 | 4.5 | 0.01 | 0.08 | 0.84 | 0.95 |
| Example 31 | 0.0500 | 0.0020 | 4.5 | 0.016 | 0.1 | 0.8 | 0.944 |
| Example 32 | 0.1000 | 0.0079 | 4.5 | 0.063 | 0.2 | 0.6 | 0.897 |
| Example 33 | 0.1500 | 0.0177 | 4.5 | 0.141 | 0.3 | 0.4 | 0.819 |
| Example 34 | 0.2000 | 0.0314 | 4.5 | 0.251 | 0.4 | 0.2 | 0.709 |
| Comparative | 0.2500 | 0.0491 | 4.5 | 0.393 | 0.5 | 0 | 0.567 |
| Example 15 | | | | | | | |
| Comparative | 0.3000 | 0.0707 | 4.5 | 0.565 | 0.6 | −0.2 | 0.395 |
| Example 16 | | | | | | | |

The turn width of the coil refers to the width of the cross-section of the coil disposed between the core and the first surface (or second surface) of the main body. The turn width is for a one coil.

The cross-sectional area of the main body refers to the cross-sectional area occupied by the magnetic body excluding the coils.

### Preparation Example 3: Manufacture of Coil Electronic Components

Coil electronic components according to Examples 35 to 47 and Comparative Examples 17 to 26 were prepared by forming a two-layered lower coil and a two-layered upper coil using conductive wires having an elliptical or circular cross-sectional shape.

Specific numerical values regarding the cross-section of the conductive wire, the coil, and the main body of the prepared coil electronic components are shown in Table 3. Meanwhile, the length, thickness, and width of the main body are 2.000 mm, 1.000 mm, and 1.200 mm, respectively, the thickness of the intermediate layer is 0.200 mm, the margin in the length direction (L-axis direction) is 0.100 mm, and the margin in the width direction (W-axis direction) is 0.500 mm.

TABLE 3

| | Cross-section of | | | Coils | | | Main body | |
|---|---|---|---|---|---|---|---|---|
| | conductive wire | | | | Cross- | | | Cross- |
| | Major | Minor | | | sectional | Turn | Core | sectional |
| | axis | axis | Area | Number | area | width | width | area |
| | (mm) | (mm) | (mm²) | of turns | (mm²) | (mm) | (mm) | (mm²) |
| Comparative | 0.02 | 0.03 | 0.00047 | 20.5 | 0.019 | 0.2 | 0.6 | 0.941 |
| Example 17 | | | | | | | | |
| Comparative | 0.03 | 0.03 | 0.00071 | 13.8 | 0.019 | 0.2 | 0.6 | 0.941 |
| Example 18 | | | | | | | | |
| Example 35 | 0.035 | 0.03 | 0.00082 | 11.9 | 0.019 | 0.2 | 0.6 | 0.941 |
| Example 36 | 0.04 | 0.03 | 0.00094 | 10.5 | 0.019 | 0.2 | 0.6 | 0.941 |
| Example 37 | 0.05 | 0.03 | 0.00118 | 8.5 | 0.019 | 0.2 | 0.6 | 0.941 |
| Example 38 | 0.1 | 0.03 | 0.00236 | 4.5 | 0.019 | 0.2 | 0.6 | 0.941 |
| Example 39 | 0.15 | 0.03 | 0.00353 | 3.2 | 0.019 | 0.2 | 0.6 | 0.941 |
| Example 40 | 0.2 | 0.03 | 0.00471 | 2.5 | 0.019 | 0.2 | 0.6 | 0.941 |
| Example 41 | 0.25 | 0.03 | 0.00589 | 2.1 | 0.019 | 0.2 | 0.6 | 0.941 |
| Example 42 | 0.3 | 0.03 | 0.00707 | 1.8 | 0.019 | 0.2 | 0.6 | 0.941 |
| Comparative | 0.8 | 0.03 | 0.01885 | 1.0 | 0.019 | 0.2 | 0.6 | 0.941 |
| Example 20 | | | | | | | | |
| Comparative | 0.9 | 0.03 | 0.02121 | 0.94 | 0.019 | 0.2 | 0.6 | 0.941 |
| Example 21 | | | | | | | | |
| Comparative | 1.0 | 0.03 | 0.02356 | 0.90 | 0.019 | 0.2 | 0.6 | 0.941 |
| Example 22 | | | | | | | | |
| Comparative | 0.02 | 0.03 | 0.00047 | 4.5 | 0.004 | 0.040 | 0.92 | 0.956 |
| Example 23 | | | | | | | | |
| Comparative | 0.03 | 0.03 | 0.00071 | 4.5 | 0.006 | 0.060 | 0.88 | 0.954 |
| Example 24 | | | | | | | | |
| Example 43 | 0.035 | 0.03 | 0.00082 | 4.5 | 0.007 | 0.070 | 0.86 | 0.953 |
| Example 44 | 0.04 | 0.03 | 0.00094 | 4.5 | 0.008 | 0.08 | 0.84 | 0.952 |
| Example 45 | 0.05 | 0.03 | 0.00118 | 4.5 | 0.009 | 0.1 | 0.8 | 0.951 |
| Example 46 | 0.1 | 0.03 | 0.00236 | 4.5 | 0.019 | 0.2 | 0.6 | 0.941 |
| Example 46 | 0.15 | 0.03 | 0.00353 | 4.5 | 0.028 | 0.3 | 0.4 | 0.932 |
| Example 47 | 0.2 | 0.03 | 0.00471 | 4.5 | 0.038 | 0.4 | 0.2 | 0.922 |
| Comparative | 0.25 | 0.03 | 0.00589 | 4.5 | 0.047 | 0.5 | 0.0 | 0.913 |
| Example 25 | | | | | | | | |
| Comparative | 0.3 | 0.03 | 0.00707 | 4.5 | 0.057 | 0.6 | −0.2 | 0.903 |
| Example 26 | | | | | | | | |

The turn width of the coil refers to the width of the cross-section of the coil disposed between the core and the first surface (or second surface) of the main body. The turn width is for a one coil.

The cross-sectional area of the main body refers to the cross-sectional area occupied by the magnetic body excluding the coils.

### Preparation Example 4: Manufacture of Coil Electronic Components

Coil electronic components according to Examples 48 to 61 and Comparative Examples 27 to 35 were prepared by forming a two-layered lower coil and a two-layered upper coil using conductive wires with a cross-sectional shape having opposing portions and curved portions.

Specific numerical values regarding the cross-section of the conductive wire, the coil, and the main body of the prepared coil electronic components are shown in Table 4. Meanwhile, the length, thickness, and width of the main body are 2.000 mm, 1.000 mm, and 1.200 mm, respectively, the thickness of the intermediate layer is 0.200 mm, the margin in the length direction (L-axis direction) is 0.100 mm, and the margin in the width direction (W-axis direction) is 0.500 mm.

TABLE 4

| | | | | Coils | | | Main body | |
|---|---|---|---|---|---|---|---|---|
| | Cross-section of | | | | Cross- | | | Cross- |
| | conductive wire | | | | sectional | Turn | Core | sectional |
| | Width | thickness | Area | Number | area | width | width | area |
| | (mm) | (mm) | (mm²) | of turns | (mm²) | (mm) | (mm) | (mm²) |
| Comparative | 0.02 | 0.03 | 0.00047 | 20.5 | 0.016 | 0.2 | 0.6 | 0.944 |
| Example 27 | | | | | | | | |
| Comparative | 0.03 | 0.03 | 0.00071 | 13.8 | 0.019 | 0.2 | 0.6 | 0.941 |
| Example 28 | | | | | | | | |
| Example 48 | 0.035 | 0.03 | 0.00082 | 11.9 | 0.020 | 0.2 | 0.6 | 0.940 |
| Example 49 | 0.04 | 0.03 | 0.00101 | 10.5 | 0.020 | 0.2 | 0.6 | 0.940 |
| Example 50 | 0.05 | 0.03 | 0.00131 | 8.5 | 0.021 | 0.2 | 0.6 | 0.939 |
| Example 51 | 0.1 | 0.03 | 0.00281 | 4.5 | 0.022 | 0.2 | 0.6 | 0.938 |
| Example 52 | 0.15 | 0.03 | 0.00431 | 3.2 | 0.023 | 0.2 | 0.6 | 0.937 |
| Example 53 | 0.2 | 0.03 | 0.00581 | 2.5 | 0.023 | 0.2 | 0.6 | 0.937 |
| Example 54 | 0.25 | 0.03 | 0.00731 | 2.1 | 0.023 | 0.2 | 0.6 | 0.937 |
| Example 55 | 0.3 | 0.03 | 0.00881 | 1.8 | 0.023 | 0.2 | 0.6 | 0.937 |
| Comparative | 0.8 | 0.03 | 0.02381 | 1.00 | 0.023 | 0.2 | 0.6 | 0.937 |
| Example 29 | | | | | | | | |
| Comparative | 0.9 | 0.03 | 0.02681 | 0.94 | 0.023 | 0.2 | 0.6 | 0.937 |
| Example 30 | | | | | | | | |
| Comparative | 1.0 | 0.03 | 0.02981 | 0.90 | 0.023 | 0.2 | 0.6 | 0.937 |
| Example 31 | | | | | | | | |
| Comparative | 0.02 | 0.03 | 0.000407 | 4.5 | 0.003 | 0.04 | 0.92 | 0.957 |
| Example 32 | | | | | | | | |
| Comparative | 0.03 | 0.03 | 0.000707 | 4.5 | 0.006 | 0.06 | 0.88 | 0.954 |
| Example 33 | | | | | | | | |
| Example 56 | 0.035 | 0.03 | 0.000857 | 4.5 | 0.007 | 0.07 | 0.86 | 0.953 |
| Example 57 | 0.04 | 0.03 | 0.00101 | 4.5 | 0.008 | 0.08 | 0.84 | 0.952 |
| Example 58 | 0.05 | 0.03 | 0.00131 | 4.5 | 0.010 | 0.1 | 0.8 | 0.950 |
| Example 59 | 0.1 | 0.03 | 0.00281 | 4.5 | 0.022 | 0.2 | 0.6 | 0.938 |
| Example 60 | 0.15 | 0.03 | 0.00431 | 4.5 | 0.034 | 0.3 | 0.4 | 0.926 |
| Example 61 | 0.2 | 0.03 | 0.00581 | 4.5 | 0.046 | 0.4 | 0.2 | 0.914 |
| Comparative | 0.25 | 0.03 | 0.00731 | 4.5 | 0.058 | 0.5 | 0 | 0.902 |
| Example 34 | | | | | | | | |
| Comparative | 0.3 | 0.03 | 0.00881 | 4.5 | 0.070 | 0.6 | −0.2 | 0.89 |
| Example 35 | | | | | | | | |

The turn width of the coil refers to the width of the cross-section of the coil disposed between the core and the first surface (or second surface) of the main body. The turn width is for a one coil.

The cross-sectional area of the main body refers to the cross-sectional area occupied by the magnetic body excluding the coils.

### EXPERIMENTAL EXAMPLE

### Experimental Example 1

The ratio of the cross-sectional area of the coil to the cross-sectional area of the main body of the coil electronic components prepared in Examples 1 to 18 and Comparative Examples 1 to 8 was measured, it was confirmed whether the coil was exposed in the thickness direction of the main body by the naked eye, it was confirmed whether the requirement that the thickness of the cross-section of the conductive wire is equal to or larger than the width was satisfied, and the results are shown in Table 5.

TABLE 5

| | Cross-sectional | Defect as to | |
|---|---|---|---|
| | area of | whether coil is | Requirement |
| | coil/cross- | exposed | regarding |
| | sectional area | (thickness | cross-sectional shape |
| | of main body | direction) | of conductive wire |
| Comparative | 0.048 | No defect | Not satisfied |
| Example 1 | | | |
| Comparative | 0.048 | No defect | Not satisfied |
| Example 2 | | | |
| Example 1 | 0.048 | No defect | Satisfied |
| Example 2 | 0.053 | No defect | Satisfied |
| Example 3 | 0.058 | No defect | Satisfied |
| Example 4 | 0.067 | No defect | Satisfied |
| Example 5 | 0.077 | No defect | Satisfied |
| Example 6 | 0.091 | No defect | Satisfied |
| Example 7 | 0.111 | No defect | Satisfied |
| Example 8 | 0.143 | No defect | Satisfied |
| Example 9 | 0.200 | No defect | Satisfied |
| Comparative | 0.263 | Defect occurred | Satisfied |
| Example 3 | | | |
| Comparative | 0.333 | Defect occurred | Satisfied |
| Example 4 | | | |
| Comparative | 0.026 | No defect | Not satisfied |
| Example 5 | | | |
| Comparative | 0.026 | No defect | Not satisfied |
| Example 6 | | | |
| Example 10 | 0.026 | No defect | Satisfied |
| Example 11 | 0.026 | No defect | Satisfied |
| Example 12 | 0.026 | No defect | Satisfied |
| Example 13 | 0.026 | No defect | Satisfied |
| Example 14 | 0.026 | No defect | Satisfied |
| Example 15 | 0.026 | No defect | Satisfied |
| Example 16 | 0.026 | No defect | Satisfied |
| Example 17 | 0.026 | No defect | Satisfied |
| Example 18 | 0.026 | No defect | Satisfied |
| Comparative | 0.026 | Defect occurred | Satisfied |
| Example 7 | | | |
| Comparative | 0.026 | Defect occurred | Satisfied |
| Example 8 | | | |

Referring to Table 5, in the coil electronic components prepared in Examples 1 to 18, the defect that the coil was exposed in the thickness direction did not occur, and the thickness of the cross-section of the conductive wire was equal to or greater than the width, satisfying the requirement regarding the cross-sectional shape of the conductive wire. In the coil electronic components prepared in Comparative Examples 1 and 2 and Comparative Examples 5 and 6, the coil was not exposed in the thickness direction, but the width of the cross-section of the conductive wire was larger than the thickness, so the requirement regarding the cross-sectional shape of the conductive wire was not satisfied.

Meanwhile, in the coil electronic components prepared in Comparative Examples 3 and 4 and Comparative Examples 7 and 8, defects occurred because the coil protruded from the outer surface of the main body in the thickness direction.

### Experimental Example 2

The ratio of the cross-sectional area of the coil to the cross-sectional area of main body of the coil electronic components prepared in Examples 19 to 34 and Comparative Examples 9 to 16 was measured, it was confirmed whether the amount of temperature change when direct current was applied satisfied the rated current (allowable current upon temperature rise, Iₜₑₘₚ) by applying a direct current to the coil electronic components and using a non-contact laser temperature sensor to verify whether the temperature change exceeded 40° C., and it was confirmed whether the coil was exposed from the main body in the thickness direction by the naked eye, and the results are shown in Table 6.

TABLE 6

| | | | | Defect as to |
|---|---|---|---|---|
| | Cross-sectional | | | whether |
| | area of coil/cross- | Amount of | | coil is |
| | sectional | temperature | | exposed |
| | area of | change | Rated | (thickness |
| | main body | (° C.) | current | direction) |
| Comparative | 0.006 | 219.989 | Not | No defect |
| Example 9 | | | satisfied | |
| Comparative | 0.012 | 40.616 | Not | No defect |
| Example 10 | | | satisfied | |
| Example 19 | 0.012 | 39.916 | Satisfied | No defect |
| Example 20 | 0.014 | 26.965 | Satisfied | No defect |
| Example 21 | 0.020 | 7.387 | Satisfied | No defect |
| Example 22 | 0.027 | 2.581 | Satisfied | No defect |
| Example 23 | 0.033 | 0.855 | Satisfied | No defect |
| Example 24 | 0.070 | −0.754 | Satisfied | No defect |
| Example 25 | 0.109 | −0.923 | Satisfied | No defect |
| Example 26 | 0.151 | −0.966 | Satisfied | No defect |
| Comparative | 0.196 | −0.982 | Satisfied | Defect |
| Example 11 | | | | occurred |
| Comparative | 0.244 | −0.989 | Satisfied | Defect |
| Example 12 | | | | occurred |
| Comparative | 0.001 | 47.517 | Not | No defect |
| Example 13 | | | satisfied | |
| Comparative | 0.001 | 40.457 | Not | No defect |
| Example 14 | | | satisfied | |
| Example 27 | 0.001 | 39.990 | Satisfied | No defect |
| Example 28 | 0.003 | 14.347 | Satisfied | No defect |
| Example 29 | 0.006 | 14.167 | Satisfied | No defect |
| Example 30 | 0.011 | 1.653 | Satisfied | No defect |
| Example 31 | 0.017 | 0.617 | Satisfied | No defect |
| Example 32 | 0.070 | −0.697 | Satisfied | No defect |
| Example 33 | 0.172 | −0.910 | Satisfied | No defect |
| Example 34 | 0.354 | −0.975 | Satisfied | No defect |
| Comparative | 0.693 | −1.000 | Satisfied | Defect |
| Example 15 | | | | occurred |
| Comparative | 1.430 | −1.011 | Satisfied | Defect |
| Example 16 | | | | occurred |

Referring to Table 6, in the coil electronic components prepared in Examples 19 to 34, the coil was not exposed in the thickness direction and the temperature increase did not exceed 40° C., satisfying the rated current. In the coil electronic components prepared in Comparative Examples 9 and 10 and Comparative Examples 13 and 14, the coil was not exposed in the thickness direction, but the temperature increase exceeded 40° C., so the rated current was not satisfied.

Meanwhile, in the coil electronic components prepared in Comparative Examples 11 and 12 and Comparative Examples 15 and 16, the temperature rise did not exceed 40° C., but defects occurred because the coil protruded from the outer surface of the main body in the thickness direction.

### Experimental Example 3

The ratio of the cross-sectional area of the coil to the cross-sectional area of the main body, the core width, and the number of turns of each coil in the coil electronic components prepared in Examples 35 to 47 and Comparative Examples 17 to 26 were measured, and it was confirmed whether the requirement that the maximum length in the length direction (L-axis direction) of the cross-section of the conductive wire is larger than the maximum length in the thickness direction (T-axis direction) was satisfied, and the results are shown in Table 7.

TABLE 7

| | Cross-sectional | | Requirement | |
|---|---|---|---|---|
| | area of | | regarding | |
| | coil/cross- | | cross- | Number of |
| | sectional | | sectional shape | turns of |
| | area of | Core width | of conductive | coil |
| | main body | (>0 mm) | wire | (>1) |
| Comparative | 0.020 | ◯ | Not satisfied | ◯ |
| Example 17 | | | | |
| Comparative | 0.0202 | ◯ | Not satisfied | ◯ |
| Example 18 | | | | |
| Example 35 | 0.0202 | ◯ | Satisfied | ◯ |
| Example 36 | 0.0202 | ◯ | Satisfied | ◯ |
| Example 37 | 0.0202 | ◯ | Satisfied | ◯ |
| Example 38 | 0.0202 | ◯ | Satisfied | ◯ |
| Example 39 | 0.0202 | ◯ | Satisfied | ◯ |
| Example 40 | 0.0202 | ◯ | Satisfied | ◯ |
| Example 41 | 0.0202 | ◯ | Satisfied | ◯ |
| Example 42 | 0.0202 | ◯ | Satisfied | ◯ |
| Comparative | 0.0202 | ◯ | Satisfied | X |
| Example 20 | | | | |
| Comparative | 0.0202 | ◯ | Satisfied | X |
| Example 21 | | | | |
| Comparative | 0.0202 | ◯ | Satisfied | X |
| Example 22 | | | | |
| Comparative | 0.004 | ◯ | Not satisfied | ◯ |
| Example 23 | | | | |
| Comparative | 0.006 | ◯ | Not satisfied | ◯ |
| Example 24 | | | | |
| Example 43 | 0.007 | ◯ | Satisfied | ◯ |
| Example 44 | 0.0084 | ◯ | Satisfied | ◯ |
| Example 45 | 0.0095 | ◯ | Satisfied | ◯ |
| Example 46 | 0.0202 | ◯ | Satisfied | ◯ |
| Example 46 | 0.0300 | ◯ | Satisfied | ◯ |
| Example 47 | 0.0412 | ◯ | Satisfied | ◯ |
| Comparative | 0.0515 | X | Satisfied | ◯ |
| Example 25 | | | | |
| Comparative | 0.0631 | X | Satisfied | ◯ |
| Example 26 | | | | |

Referring to Table 7, the width of the core of the coil electronic components prepared in Examples 35 to 47 was greater than 0 mm, the maximum length in the length direction (L-axis direction) of the cross-section of the conductive wire was larger than the maximum length in the thickness direction (T-axis direction), satisfying the requirement regarding the cross-sectional shape of the conductive wire, and the number of turns of the coil was greater than 1. Meanwhile, in the coil electronic components prepared in Comparative Examples 17 and 18 and Comparative Examples 23 and 24, the maximum length in the length direction (L-axis direction) of the cross-section of the conductive wire was equal to or smaller than the maximum length in the thickness direction (T-axis direction), so the requirement regarding the cross-sectional shape of the conductive wire was not satisfied. The number of turns of the coil of the coil electronic components prepared in Comparative Examples 20, 21, and 22 was 1 or less. The core width of the coil electronic components prepared in Comparative Examples 25 and 26 was 0 mm or less.

### Experimental Example 4

The ratio of the cross-sectional area of the coil to the cross-sectional area of the main body, the core width, and the number of turns of the coils in the coil electronic components prepared in Examples 48 to 61 and Comparative Examples 27 to 35 were measured, and it was confirmed whether the requirement that the width of the cross-section of the conductive wire is greater than the thickness was satisfied, and the results are shown in Table 8.

TABLE 8

| | Cross-sectional | | | |
|---|---|---|---|---|
| | area of coil/ | | Requirement | Number |
| | cross-sectional | Core | regarding cross- | of turns |
| | area of main | width | sectional shape of | of coil |
| | body | (>0 mm) | conductive wire | (>1) |
| Comparative | 0.0172 | ◯ | Not satisfied | ◯ |
| Example 27 | | | | |
| Comparative | 0.0200 | ◯ | Not satisfied | ◯ |
| Example 28 | | | | |
| Example 48 | 0.0208 | ◯ | Satisfied | ◯ |
| Example 49 | 0.0213 | ◯ | Satisfied | ◯ |
| Example 50 | 0.0224 | ◯ | Satisfied | ◯ |
| Example 51 | 0.0235 | ◯ | Satisfied | ◯ |
| Example 52 | 0.0245 | ◯ | Satisfied | ◯ |
| Example 53 | 0.0245 | ◯ | Satisfied | ◯ |
| Example 54 | 0.0245 | ◯ | Satisfied | ◯ |
| Example 55 | 0.0245 | ◯ | Satisfied | ◯ |
| Comparative | 0.0245 | ◯ | Satisfied | X |
| Example 29 | | | | |
| Comparative | 0.0245 | ◯ | Satisfied | X |
| Example 30 | | | | |
| Comparative | 0.0245 | ◯ | Satisfied | X |
| Example 31 | | | | |
| Comparative | 0.0034 | ◯ | Not satisfied | ◯ |
| Example 32 | | | | |
| Comparative | 0.0059 | ◯ | Not satisfied | ◯ |
| Example 33 | | | | |
| Example 56 | 0.0072 | ◯ | Satisfied | ◯ |
| Example 57 | 0.0084 | ◯ | Satisfied | ◯ |
| Example 58 | 0.0105 | ◯ | Satisfied | ◯ |
| Example 59 | 0.0235 | ◯ | Satisfied | ◯ |
| Example 60 | 0.0367 | ◯ | Satisfied | ◯ |
| Example 61 | 0.0503 | ◯ | Satisfied | ◯ |
| Comparative | 0.0643 | X | Satisfied | ◯ |
| Example 34 | | | | |
| Comparative | 0.0787 | X | Satisfied | ◯ |
| Example 35 | | | | |

Referring to Table 8, the width of the core of the coil electronic component prepared in Examples 48 to 61 was greater than 0 mm, the width of the cross-section of the conductive wire was larger than the thickness, satisfying the requirement regarding the cross-sectional shape of the conductive wire, and the number of turns of the coil was greater than 1.

Meanwhile, the width of the core of the coil electronic components prepared in Comparative Examples 27 and 28 and Comparative Examples 32 and 33 was equal to or smaller than the thickness, so the requirement regarding the cross-sectional shape of the conductive wire was not satisfied. The number of turns of the coil of the coil electronic components prepared in Comparative Examples 29, 30, and 31 was 1 or less. The core width of the coil electronic components prepared in Comparative Examples 34 and 35 was 0 mm or less.

While the disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A coil electronic component comprising:
a first coil comprising a first core and at least one turn of a first conductive wire;
a second coil comprising a second core and at least one turn of a second conductive wire, the second coil opposing the first coil along a first direction;
an intermediate layer disposed from a first region between the first core and the second core to a second region between the first coil and the second coil, the intermediate layer comprising a first magnetic material; and
a main body surrounding the first coil, the second coil, and the intermediate layer, the main body comprising a second magnetic material,
wherein a cross-section of the first conductive wire has a rectangular shape and satisfies Formula 1, and
a cross-section of the second conductive wire has a rectangular shape and satisfies Formula 2:
$$0 < w 1 \leq t 1 < T 1 / 2 \qquad [ Formula 1 ]$$
$$0 < w {1}^{′} \leq t {1}^{′} < T 1 / 2 \qquad [ Formula 2 ]$$
where,
t1: thickness of the cross-section of the first conductive wire
w1: width of the cross-section of the first conductive wire
t1′: thickness of the cross-section of the second conductive wire
w1′: width of the cross-section of the second conductive wire
T1: thickness of the main body.

2. The coil electronic component of claim 1, wherein:
based on a cross-section of the coil electronic component taken along a direction parallel to the first direction,
a ratio of a sum of cross-sectional areas of the first coil and the second coil to a cross-sectional area of the main body is 0.048 or more and 0.200 or less.

3. The coil electronic component of claim 2, wherein:
the first coil comprises 7.81 turns or more and 27.17 turns or less of the first conductive wire, and the second coil comprises 7.81 turns or more and 27.17 turns or less of the second conductive wire.

4. The coil electronic component of claim 1, wherein:
w1, t1, w1′, and t1′ satisfy the following ranges, respectively:
$$\begin{matrix}0.0075 \leq w 1 / L 1 \leq 0.02735 , 0.0548 \leq t 1 / T 1 = 0.2 , \\ 0.0075 \leq w {1}^{′} / L 1 \leq 0.02735 , 0.0548 \leq t {1}^{′} / T 1 = 0.2 ,\end{matrix}$$
where,
L1: length of the main body.

5. The coil electronic component of claim 1, wherein:
the first coil comprises 4.5 turns of the first conductive wire,
the second coil comprises 4.5 turns of the second conductive wire,
a value obtained by dividing a width of the first core by a length of the main body is 0.3905 or more and 0.47 or less, and
a value obtained by dividing a width of the second core by the length of the main body is 0.3905 or more and 0.47 or less.

6. The coil electronic component of claim 5, wherein:
based on a cross section taken along a direction parallel to the first direction,
a ratio of a sum of cross-sectional areas of the first coil and the second coil to a cross-sectional area of the main body is 0.025 to 0.027.

7. A coil electronic component comprising:
a first coil comprising a first core and at least one turn of a first conductive wire;
a second coil comprising a second core and at least one turn of a second conductive wire, the second coil opposing the first coil along a first direction;
an intermediate layer disposed from a first region between the first core and the second core to a second region between the first coil and the second coil, the intermediate layer comprising a first magnetic material; and
a main body surrounding the first coil, the second coil, and the intermediate layer, the main body comprising a second magnetic material,
wherein a cross-section of the first conductive wire has a circular shape and satisfies Formula 3, and
a cross-section of the second conductive wire has a circular shape and satisfies Formula 4:
$$0 < D 1 < L 2 / 2 \qquad [ Formula 3 ]$$
$$0 < D 2 < L 2 / 2 \qquad [ Formula 4 ]$$
where,
D1: diameter of the cross-section of the first conductive wire
D2: diameter of the cross-section of the second conductive wire
L2: length of the main body.

8. The coil electronic component of claim 6, wherein:
based on a cross-section of the coil electronic component taken along a direction parallel to the first direction,
a ratio of a sum of cross-sectional areas of the first coil and the second coil to a cross-sectional area of the main body is 0.012 or more and 0.151 or less.

9. The coil electronic component of claim 8, wherein:
the first coil comprises 2.5 turns or more and 23.2 turns or less of the first conductive wire, and the second coil comprises 2.5 turns or more and 23.2 turns or less of the second conductive wire.

10. The coil electronic component of claim 7, wherein:
D1 and D2 satisfy the following ranges, respectively:
$$\begin{matrix}0.0088 < D 1 / L 2 \leq 0.100 , 0.0088 < D 2 / L 2 \leq 0.1 \; 00 , \\ 0.0176 < D 1 / T 2 \leq 0.200 , 0.0176 < D 2 / T 2 \leq 0.200 ,\end{matrix}$$
where,
L2: length of the main body
T2: thickness of the main body.

11. The coil electronic component of claim 7, wherein:
the first coil comprises 4.5 turns of the first conductive wire,
the second coil comprises 4.5 turns of the second conductive wire,
a value obtained by dividing a width of the first core by the length of the main body is 0.1 or more and 0.4785 or less, and
a value obtained by dividing a width of the second core by the length of the main body is 0.1 or more and 0.4785 or less.

12. The coil electronic component of claim 11, wherein:
based on a cross-section taken along a direction parallel to the first direction,
a ratio of a sum of cross-sectional areas of the first coil and the second coil to a cross-sectional area of the main body is 0.001 or more and 0.354 or less.

13. A coil electronic component comprising:
a first coil comprising a first core and at least one turn of a first conductive wire;
a second coil comprising a second core and at least one turn of a second conductive wire, the second coil opposing the first coil along a first direction;
an intermediate layer disposed from a first region between the first core and the second core to a second region between the first coil and the second coil, the intermediate layer comprising a first magnetic material; and
a main body surrounding the first coil, the second coil, and the intermediate layer, the main body comprising a second magnetic material,
wherein a cross-section of the first conductive wire has an elliptical shape and satisfies Formula 5, and
a cross-section of the second conductive wire has an elliptical shape and satisfies Formula 6:
$$0 < b 1 < a 1 < L 3 / 2 \qquad [ Formula 5 ]$$
$$0 < b 2 < a 2 < L 3 / 2 \qquad [ Formula 6 ]$$
where,
a1: length of a major axis of the cross-section of the first conductive wire
b1: length of a minor axis of the cross-section of the first conductive wire
a2: length of a major axis of the cross-section of the second conductive wire
b2: length of a minor axis of the cross-section of the second conductive wire
L3: length of the main body.

14. The coil electronic component of claim 13, wherein:
based on a cross section taken along a direction parallel to the first direction,
a ratio of a sum of cross-sectional areas of the first coil and the second coil to a cross-sectional area of the main body is 0.0201 to 0.0205.

15. The coil electronic component of claim 14, wherein:
the first coil comprises 1.8 turns or more and 11.9 turns or less of the first conductive wire, and the second coil comprises 1.8 turns or more and 11.9 turns or less of the second conductive wire.

16. The coil electronic component of claim 15, wherein:
a1, b1, a2, and b2 satisfy the following ranges, respectively:
$$\begin{matrix}0.0175 \leq a 1 / L 3 \leq 0.150 , 0.028 < b 1 / T 3 < 0.032 \\ 0.0175 \leq a 2 / L 3 \leq 0.150 , 0.028 < b 2 / T 3 < 0.032\end{matrix}$$
where,
L3: length of the main body
T3: thickness of the main body.

17. The coil electronic component of claim 13, wherein:
the first coil comprises 4.5 turns of the first conductive wire,
the second coil comprises 4.5 turns of the second conductive wire,
a value obtained by dividing a width of the first core by the length of the main body is 0.1 or more and 0.43 or less, and
a value obtained by dividing a width of the second core by the length of the main body is 0.1 or more and 0.43 or less.

18. The coil electronic component of claim 17, wherein:
based on a cross section taken along a direction parallel to the first direction,
a ratio of a sum of cross-sectional areas of the first coil and the second coil to a cross-sectional area of the main body is 0.007 or more and 0.0412 or less.

19. The coil electronic component of claim 18, wherein:
a1, b1, a2, and b2 satisfy the following ranges, respectively:
$$\begin{matrix}0.0175 \leq a 1 / L 3 \leq 0.1 \; 00 , 0.028 < b 1 / T 3 < 0.03 \\ 0.0175 \leq a 2 / L 3 \leq 0.1 \; 00 , 0.028 < b 2 / T 3 < 0.03\end{matrix}$$
where,
L3: length of the main body
T3: thickness of the main body.

20. A coil electronic component comprising:
a first coil comprising a first core and at least one turn of a first conductive wire;
a second coil comprising a second core and at least one turn of a second conductive wire, the second coil opposing the first coil along a first direction;
an intermediate layer disposed from a first region between the first core and the second core to a second region between the first coil and the second coil, the intermediate layer comprising a first magnetic material; and
a main body surrounding the first coil, the second coil, and the intermediate layer, the main body comprising a second magnetic material,
wherein a cross-section of each of the first conductive wire and the second conductive wire comprises opposing portions that oppose each other and a curved portion that connects the opposing portions,
the cross-section of the first conductive wire satisfies Formula 7, and
the cross-section of the second conductive wire satisfies Formula 8:
$$0 < t 2 < w 2 < L 4 / 2 \qquad [ Formula 7 ]$$
$$0 < t {2}^{′} < w {2}^{′} < L 4 / 2 \qquad [ Formula 8 ]$$
where,
t2: thickness of the cross-section of the first conductive wire
w2: width of the cross-section of the first conductive wire
t2′: thickness of the cross-section of the second conductive wire
w2′: width of the cross-section of the second conductive wire
L4: length of the main body.

21. The coil electronic component of claim 20, wherein:
based on a cross section taken along a direction parallel to the first direction,
a ratio of a sum of cross-sectional areas of the first coil and the second coil to a cross-sectional area of the main body is 0.0208 or more and 0.0245 or less.

22. The coil electronic component of claim 21, wherein:
the first coil comprises 1.8 turns or more and 11.9 turns or less of the first conductive wire, and the second coil comprises 1.8 turns or more and 11.9 turns or less of the second conductive wire.

23. The coil electronic component of claim 22, wherein:
w2, t2, w2′, and t2′ satisfy the following ranges, respectively:
$$\begin{matrix}0.0175 \leq w 1 / L 4 \leq 0.15 , 0.0 \; 28 < t 2 / T 4 < 0.032 \\ 0.0175 \leq w {2}^{′} / L 4 \leq 0.15 , 0.0 \; 28 < t {2}^{′} / T 4 < 0.032\end{matrix}$$
where,
L4: length of the main body
T4: thickness of the main body.

24. The coil electronic component of claim 20, wherein:
the first coil comprises 4.5 turns of the first conductive wire,
the second coil comprises 4.5 turns of the second conductive wire,
a value obtained by dividing a width of the first core by the length of the main body is 0.1 or more and 0.43 or less, and
a value obtained by dividing a width of the second core by the length of the main body is 0.1 or more and 0.43 or less.

25. The coil electronic component of claim 24, wherein:
based on a cross section taken along a direction parallel to the first direction,
a ratio of a sum of cross-sectional areas of the first coil and the second coil to a cross-sectional area of the main body is 0.0072 or more and 0.0503 or less.

26. The coil electronic component of claim 25, wherein:
w2, t2, w2′, and t2′ satisfy the following ranges, respectively:
$$\begin{matrix}0.0175 \leq w 2 / L 4 \leq 0.1 , 0.0 \; 28 < t 2 / T 4 < 0.032 \\ 0.0175 \leq w {2}^{′} / L 4 \leq 0.1 , 0.0 \; 28 < t {2}^{′} / T 4 < 0.032\end{matrix}$$
where,
L4: length of the main body
T4: thickness of the main body.

27. A coil electronic component comprising:
a first coil comprising a first core and at least one turn of a first conductive wire, the first coil including a first outer layer and a first inner layer;
a second coil comprising a second core and at least one turn of a second conductive wire, the second coil opposing the first coil along a first direction and including a second outer layer and a second inner layer, wherein the second inner layer is on the first inner layer;
an intermediate layer disposed from a first region between the first core and the second core to a second region between the first coil and the second coil, the intermediate layer comprising a first magnetic material; and
a main body surrounding the first coil, the second coil, and the intermediate layer, the main body comprising a second magnetic material,
wherein a cross-section of the first conductive wire has a rectangular shape and satisfies Formula 1,
wherein a cross-section of the second conductive wire has a rectangular shape and satisfies Formula 2:
$$0 < w 1 \leq t 1 < T 1 / 2 \qquad [ Formula 1 ]$$
$$0 < w {1}^{′} \leq t {1}^{′} < T 1 / 2 \qquad [ Formula 2 ]$$
where,
t1: thickness of the cross-section of the first conductive wire
w1: width of the cross-section of the first conductive wire
t1′: thickness of the cross-section of the second conductive wire
w1′: width of the cross-section of the second conductive wire
T1: thickness of the main body, and
wherein, based on a cross-section of the coil electronic component taken along a direction parallel to the first direction, a ratio of a sum of cross-sectional areas of the first coil and the second coil to a cross-sectional area of the main body is 0.048 or more and 0.200 or less.

28. The coil electronic component of claim 27, wherein w1, t1, w1′, and t1′ satisfy the following ranges, respectively:
$$\begin{matrix}0.0075 \leq w 1 / L 1 \leq 0.02735 , 0.0548 < t 1 / T14 < 0.2 , \\ 0.0075 \leq w {1}^{′} / L 1 \leq 0.02735 , 0.0548 < t {1}^{′} / T 1 < 0.2 ,\end{matrix}$$
where L1: length of the main body.

29. The coil electronic component of claim 28, wherein the first coil comprises 7.81 turns or more and 27.17 turns or less of the first conductive wire.

30. The coil electronic component of claim 29, wherein the second coil comprises 7.81 turns or more and 27.17 turns or less of the second conductive wire.

31. A coil electronic component comprising:
a first coil comprising a first core and at least one turn of a first conductive wire, the first coil including a first outermost turn coil, and a first intermediate turn coil having a central axis that is eccentric from a central axis of the first outermost turn coil;
a second coil comprising a second core and at least one turn of a second conductive wire, the second coil opposing the first coil along a first direction;
an intermediate layer disposed from a first region between the first core and the second core to a second region between the first coil and the second coil, the intermediate layer comprising a first magnetic material; and
a main body surrounding the first coil, the second coil, and the intermediate layer, the main body comprising a second magnetic material,
wherein:
a cross-section of the first conductive wire has a circular shape and satisfies Formula 3, and
a cross-section of the second conductive wire has a circular shape and satisfies Formula 4:
$$0 < D 1 < L 2 / 2 \qquad [ Formula 3 ]$$
$$0 < D 2 < L 2 / 2 \qquad [ Formula 4 ]$$
where,
D1: diameter of the cross-section of the first conductive wire
D2: diameter of the cross-section of the second conductive wire
L2: length of the main body.

32. The coil electronic component of claim 31, the second coil includes a second outermost turn coil, and a second intermediate turn coil having a central axis that is eccentric from a central axis of the second outermost turn coil.

33. The coil electronic component of claim 32, wherein, based on a cross-section of the coil electronic component taken along a direction parallel to the first direction, a ratio of a sum of cross-sectional areas of the first coil and the second coil to a cross-sectional area of the main body is 0.012 or more and 0.151 or less.

34. The coil electronic component of claim 33, wherein D1 and D2 satisfy the following ranges, respectively:
$$\begin{matrix}0.0088 < D 1 / L 2 \leq 0.100 , 0.0088 < D 2 / L 2 \leq 0.1 \; 00 , \\ 0.0176 < D 1 / T 2 \leq 0.200 , 0.0176 < D 2 / T 2 \leq 0.200 ,\end{matrix}$$
where T2: thickness of the main body.

35. The coil electronic component of claim 32, wherein the first coil comprises 2.5 turns or more and 23.2 turns or less of the first conductive wire.

36. The coil electronic component of claim 35, wherein the second coil comprises 2.5 turns or more and 23.2 turns or less of the second conductive wire.
